(19) United States
(12) Patent Application Publication
(10) Pub. No.: US 2010/0135389 A1
(43) Pub. Date: Jun. 3, 2010

(54) METHOD AND APPARATUS FOR IMAGE ENCODING AND IMAGE DECODING

(76) Inventors: Akiyuki TANIZAWA, Kawasaki-shi (JP); Taichiro Shiodera, Tokyo (JP); Takeshi Chujoh, Kawasaki-shi (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/647,112

(22) Filed: Dec. 24, 2009

Related U.S. Application Data
(63) Continuation of application No. PCT/JP08/61412, filed on Jun. 23, 2008.

(30) Foreign Application Priority Data
Jun. 26, 2007 (JP) 2007-168119

(51) Int. Cl. H04N 7/50

(52) U.S. Cl. 375/240.12; 375/E07.211

(57) ABSTRACT

An image encoding apparatus includes a transform/quantization unit configured to perform transform and quantization with respect to a prediction error signal indicative of a difference value between a predicted image signal and an input image signal in order to generate a quantized transform coefficient, a encoding unit configured to perform entropy encoding with respect to the quantized transform coefficient in order to generate encoded data, a derivation unit configured to derive prediction complexity indicative of a degree of complication of the prediction processing, a determination unit configured to determine filtering strength for a locally decoded image signal to become low as the prediction complexity increases, a filter unit configured to perform deblocking filter processing with respect to the locally decoded image signal in accordance with the filtering strength, and a storage unit configured to store the locally decoded image signal after the deblocking filter processing.

### CROSS-REFERENCE TO RELATED APPLICATIONS

This is a Continuation Application of PCT Application No. PCT/JP2008/061412, filed Jun. 23, 2008, which was published under PCT Article 21(2) in Japanese.

This application is based upon and claims the benefit of priority from prior Japanese Patent Application No. 2007-168119, filed Jun. 26, 2007, the entire contents of which are incorporated herein by reference.

### BACKGROUND OF THE INVENTION

1. Field of the Invention

The present invention relates to a method and an apparatus for image coding for a moving image or a still image.

2. Description of the Related Art

In recent years, an image coding method having a greatly improved coding efficiency is recommended as ITU-T Rec. H.264 and ISO/IEC 14496-10 (which will be referred to as H.264 hereinafter) by both ITU-T and ISO/IEC. In H.264, prediction processing, transform processing, and entropy coding processing are carried out in rectangular blocks. Therefore, a difference in distortions at a block boundary which is so-called block distortion may be possibly produced. To reduce the block distortion, a block distortion reducing filter called a deblocking filter is defined as in-loop processing, and it functions as one of useful tools for reducing the block distortion and improving the coding efficiency (G. Bjontegaard, “Deblocking filter for 4×4 based coding”, ITU-T Q. 15/SG16 VCEG document, Q15-J-27, May 2000.: Reference 1).

Since the block distortion often occurs when coding is carried out in a high compression state, deblocking filter processing is designed to be adaptively performed in accordance with a region where the block distortion becomes obvious by changing a threshold value of the filter depending on a value of a quantization parameter.

On the other hand, when adopting the deblocking filter, a method for controlling a tap length or a filter coefficient of a filter that is utilized in accordance with filtering strength is suggested (A. Joch, “Loop Filter Simplification and Improvement”, Joint Video Team of ISO/IEC MPEG & ITU-T VCEG, JVT-D037, July 2002/: Reference 2).

Further, a method for utilizing inter-block prediction mode information, motion vector information, coded frame reference information, and others to determine the filtering strength is suggested (JP-A 2004-96719 (KOKAI): Reference 3).

According to the technique in Reference 1, an object is to reduce block distortions, and filter processing is carried out in accordance with a signal value at a block boundary of a locally decoded image. Therefore, deblocking filter processing may be possibly performed with respect to an edge that is present in an input image as an original image depending on a setting of a threshold value, and hence an image quality difference between the input image and a decoded image may become considerable in some cases.

On the other hand, according to the technique disclosed in Reference 2 or Reference 3, it is defined that high filtering strength is set when a target block coding mode is intra-prediction, and hence an image quality difference may likewise become considerable in some cases.

### BRIEF SUMMARY OF THE INVENTION

According to an aspect of the present invention, there is provided an image encoding method comprising: performing prediction processing using a reference image signal in compliance with a selected prediction mode with respect to a target block of an input image signal that is input in blocks obtained by dividing an image frame to generate a predicted image signal in prediction blocks; generating a prediction error signal of the predicted image signal with respect to the input image signal; performing transform and quantization with respect to the prediction error signal to generate a quantized transform coefficient; performing entropy encoding with respect to the quantized transform efficiency to generate encoded data; performing inverse quantization and inverse transform with respect to the quantized transform coefficient to generate a decoded prediction error signal; adding the predicted image signal to the decoded prediction error signal to generate a locally decoded image signal; deriving prediction complexity indicative of a degree of complication of the prediction processing; determining filtering strength for the locally decoded image signal in such a manner that it becomes lower as the prediction complexity increases; performing deblocking filter processing with respect to the locally decoded image signal in accordance with the filtering strength; and storing the locally decoded image signal after the deblocking filter processing to be used as the reference image signal.

According to another aspect of the present invention, there is provided an image decoding method comprising: performing entropy decoding with respect to input encoded data to generate prediction information including a prediction mode and a quantized transform coefficient; performing prediction processing using a reference image signal in compliance with the prediction mode to generate a predicted image signal in prediction blocks; performing inverse quantization and inverse transform with respect to the quantized transform coefficient to generate a prediction error signal; adding the predicted image signal to the prediction error signal to generate a decoded image signal; deriving prediction complexity indicative of a degree of complication in the prediction processing; determining filtering strength for the decoded image signal in such a manner that it becomes lower as the prediction complexity increases; performing deblocking filter processing with respect to the decoded image signal in accordance with the filtering strength; storing the decoded image signal after the deblocking filter processing to be used as the reference image signal; and outputting the decoded image signal after the deblocking filter processing to be output as an output image signal.

### BRIEF DESCRIPTION OF THE SEVERAL VIEWS OF THE DRAWING

FIG. 1 is a block diagram showing an image encoding apparatus according to first and second embodiments;

FIG. 2 is a view showing a flow of encoding processing;

FIG. 3 is a view showing a 16×16 pixel block;

FIG. 4 is a view showing information included in a coding parameter;

FIG. 5A is a view showing a 4×4 pixel block;

FIG. 5B is a view showing an 8×8 pixel block;

FIG. 6 is a block diagram showing a prediction unit according to first to fourth embodiments;

FIG. 7 is a view showing prediction directions of intra-prediction;

FIG. 8 is a view showing a prediction method of vertical prediction (a mode 0) of the intra-prediction;

FIG. 9A is a view showing a position to which deblocking filter processing which is performed for a target block in a vertical direction is applied;

FIG. 9B is a view showing a position to which deblocking filter processing which is performed for a target block in a horizontal direction is applied;

FIG. 10 is a view showing the arrangement of target pixels and adjacent pixels utilized for the deblocking filter processing at a target block boundary;

FIG. 11 is a view showing the allocation of filtering strength at a block boundary in a macro block;

FIG. 12 is a block diagram showing a filtering strength determination unit;

FIG. 13A is a view showing a relationship between each prediction mode, each prediction method, and each prediction complexity allocated to a corresponding prediction method;

FIG. 13B is a view showing a relationship between each prediction mode, each prediction method, and each prediction complexity allocated to a corresponding prediction method;

FIG. 14A is a view showing a relationship between each prediction block index, each prediction block size, and each prediction complexity allocated to a corresponding prediction block size in case of intra-prediction;

FIG. 14B is a view showing a relationship between each prediction block index, each prediction block size, and each prediction complexity allocated to a corresponding prediction block size in case of inter-prediction;

FIG. 15A is a view showing each block prediction order, each prediction accuracy, and each prediction complexity allocated to a corresponding prediction accuracy;

FIG. 15B is a view showing each block prediction order, each prediction accuracy, and each prediction complexity allocated to a corresponding prediction accuracy;

FIG. 16 is a view showing slice header information included in encoded data;

FIG. 17 is a flowchart showing a flow of filtering strength determination processing;

FIG. 18 is a flowchart showing a flow of the filtering strength determination processing;

FIG. 19 is a flowchart showing a flow of the filtering strength determination processing;

FIG. 20 is a view showing an intra-prediction unit in a second embodiment;

FIG. 21A is a view showing a prediction order of blocks in raster block prediction;

FIG. 21B is a view showing a prediction order of blocks in inverse raster block prediction;

FIG. 22A is a view showing a prediction method of 8×8 pixel intra-prediction in the inverse raster block prediction;

FIG. 22B is a view showing a prediction method of 4×4 pixel intra-prediction in the inverse raster block prediction;

FIG. 23A is a view showing a relationship between coded blocks and uncoded blocks in the 8×8 pixel intra-prediction in the inverse raster block prediction;

FIG. 23B is a view showing a relationship between coded blocks and uncoded blocks in the 8×8 pixel intra-prediction in the inverse raster block prediction;

FIG. 23C is a view showing a relationship between coded blocks and uncoded blocks in the 8×8 pixel intra-prediction in the inverse raster block prediction;

FIG. 23D is a view showing a relationship between coded blocks and uncoded blocks in the 8×8 pixel intra-prediction in the inverse raster block prediction;

FIG. 24 is a view for explaining vertical prediction (a mode 0) of extrapolation blocks;

FIG. 25 is a view showing prediction directions of the intra-prediction;

FIG. 26A is a view for explaining inverse vertical prediction of the inverse raster block prediction;

FIG. 26B is a view for explaining the inverse vertical prediction of the inverse raster block prediction;

FIG. 27 is a view showing a relationship between each prediction switching flag, each prediction method, and each prediction complexity allocated to a corresponding prediction method;

FIG. 28A is a view showing a relationship between each prediction block index, each block prediction method, and each prediction complexity allocated to a corresponding block prediction method;

FIG. 28B is a view showing a relationship between each block prediction method, each distance from a reference pixel, and each prediction complexity allocated to a corresponding distance from the reference pixel;

FIG. 29A is a view showing a relationship between each prediction block index, each number of available reference pixels, and each prediction complexity allocated to a corresponding number of available reference pixels at the time of raster block prediction;

FIG. 29B is a view showing a relationship between each block prediction method, each distance from a reference pixel, and each prediction complexity allocated to a corresponding distance from the reference pixel at the time of inverse raster block prediction;

FIG. 30 is a flowchart showing a flow of filtering strength determination processing;

FIG. 31 is a flowchart showing a flow of the filtering strength determination processing; and

FIG. 32 is a block diagram showing a pixel decoding apparatus according to the third and fourth embodiments.

### DETAILED DESCRIPTION OF THE INVENTION

Embodiments according to the present invention will now be described hereinafter with reference to the drawings.

### <Image Encoding Apparatus>

### First Embodiment

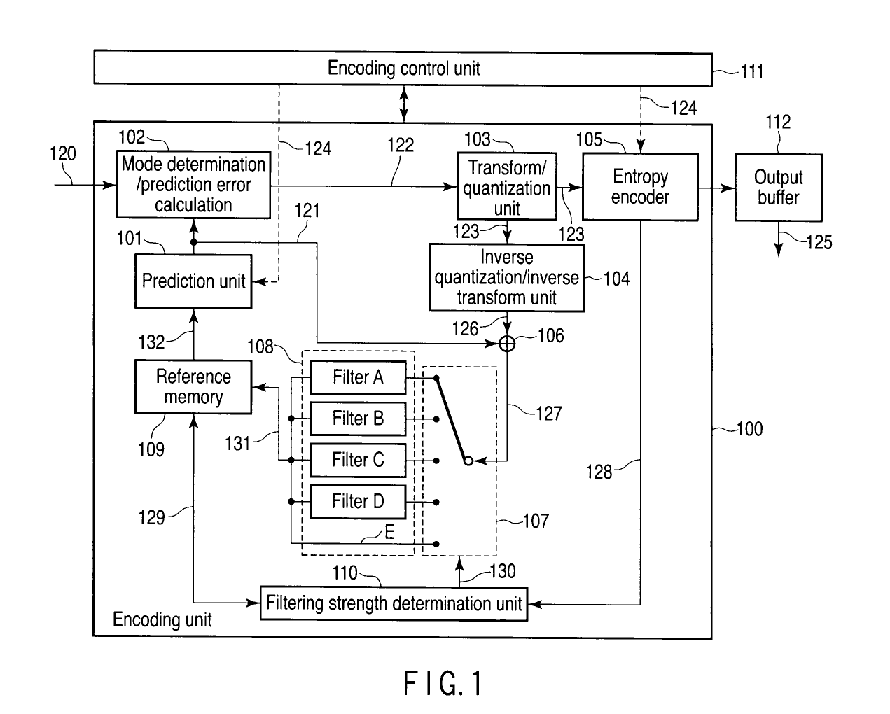

Referring to FIG. 1, in an image encoding apparatus according to a first embodiment of the present invention, an input image signal 120 of a moving image or a still image in units of frame or field is divided in accordance with each small pixel block, e.g., each macro block (MB) and input to a encoding unit 100. Here, the macro block is determined as a basic processing block size of encoding processing. A coding target macro block of the input image signal 120 will be simply referred to as a target block hereinafter.

In the encoding unit 100, a plurality of prediction modes having different block sizes or predicted image signal generation methods are prepared.

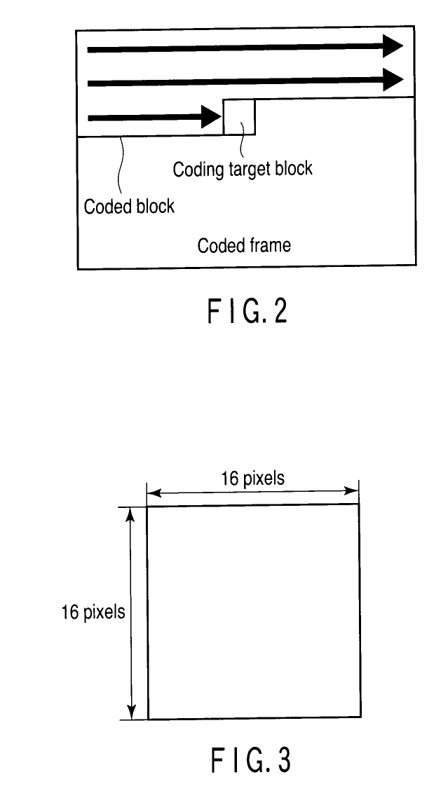

As the predicted image signal generation methods, specifically, there are roughly in-frame prediction for performing prediction in a coding target frame alone and inter-frame prediction for performing prediction by using a plurality of reference frames which are different in terms of time. In this embodiment, it is determined that coding processing is carried out from an upper left side toward a lower right side as shown in FIG. 2 for ease of explanation.

Although the macro block is typically such a 16×16 pixel block as shown in FIG. 3, a 32×32 pixel block unit or an 8×8 pixel block unit may be adopted, and a shape of the macro block does not have to be a square lattice.

The encoding unit 100 is a device that performs compression encoding in accordance with each target block of the input image signal 120 to output a code string, and it includes a prediction unit 101, a mode determination/prediction error calculation unit 102, a transform/quantization unit 103, an inverse quantization/inverse transform unit 104, an entropy encoder 105, an adder 106, a filtering strength changeover switch 107, a deblocking filter unit 108, a reference memory 109, and a filtering strength determination unit 110. A encoding control unit 111 and an output buffer 112 are provided outside the encoding unit 100. The image encoding apparatus depicted in FIG. 1 is realized by hardware such as an LSI chip or realized by executing an image encoding program in a computer.

The input image signal 120 is input to the mode determination/prediction error calculation unit 102. To the mode determination/prediction error calculation unit 102 is further input a predicted image signal 121 that is generated by respective prediction modes, e.g., the intra-prediction or the inter-prediction. The mode determination/prediction error calculation unit 102 has a function of performing a mode determination which will be described later in detail and subtracting the predicted image signal 121 from the input image signal 120 to calculate a prediction error signal 122. The prediction error signal 122 output from the mode determination/prediction error calculation unit 102 is input to the transform/quantization unit 103.

In the transform/quantization unit 103, orthogonal transform such as discrete cosine transform (DCT) is effected with respect to the prediction error signal 122 to generate a transform coefficient. Further, in the transform/quantization unit 103, the transform coefficient is quantized in accordance with quantization information including a quantization parameter and a quantization matrix given by the encoding control unit 111, thereby outputting a transform coefficient subjected to quantization (a quantized transform coefficient) 123. Here, although such discrete cosine transform as utilized in H.264 has been described as a transform method in the transform/quantization unit 103, a technique such as discrete sine transform, wavelet transform, or independent component analysis may be used.

The quantized transform coefficient 123 output from the transform/quantization unit 103 is input to the inverse quantization/inverse transform unit 104 and the entropy encoder 105. In the entropy encoder 105, entropy encoding, e.g., Huffman coding or arithmetic coding is executed with respect to various coding parameters utilized when encoding a target block including a quantized transform coefficient 118, prediction information 124 output from the encoding control unit 111, and others, thereby generating encoded data. Here, the coding parameters mean various parameters which are required when decoding not only prediction information 124 but also information concerning the transform coefficient or information concerning quantization.

The encoded data generated by the entropy encoder 105 is output from the encoding unit 100, multiplexed to be temporarily stored in the output buffer 112, and then output to the outside of the image encoding apparatus as encoded data 125 in accordance with an output timing managed by the encoding control unit 111. The encoded data 125 is supplied to a non-illustrated storage system (a storage medium) or transmission system (a communication line).

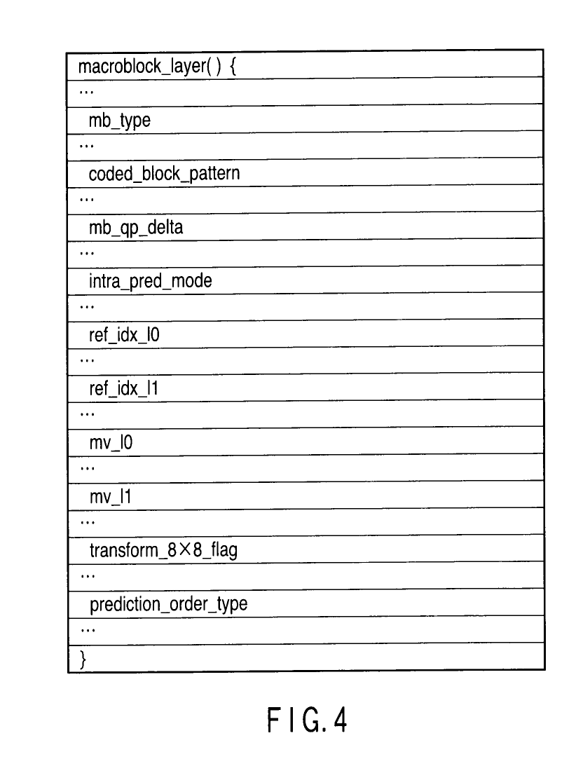

FIG. 4 shows syntax elements defined by macro block levels as examples of the coding parameter. Each element is as follows. mb_type includes macro block type information, i.e., information indicating which one of intra-coding and inter-coding is utilized to code a current macro block. coded_block_pattern indicates whether a transform coefficient is present in accordance with each 8×8 pixel block. For example, when a value of coded_block_pattern is 0, this means that no transform coefficient is present in a target block. mb_qp_delta indicates information concerning a quantization parameter, and it represents a difference value from a quantization parameter of a block that is coded immediately before a target block. intra_pred_mode is indicative of a prediction mode representing a prediction method of the intra-prediction. Each of ref_idx_10 and ref_idx_11 is indicative of a reference image index representing a reference image that is utilized for predicting a target block when the inter-prediction is selected. Each of mv_10 and mv_11 indicates motion vector information. transform_{—}8×8_flag is indicative of transform information showing whether a target block is an 8×8 pixel block. prediction_order_type is indicative of a type of a prediction order for a target block. For example, each target block is processed in a raster scan order when prediction_order_type is 0, and it is processed in an inverse raster scan order when prediction_order_type is 1.

A syntax element which is not defined in this embodiment in particular can be inserted into a space between lines in FIG. 4, or a description concerning any other conditional branching may be included in this space. A syntax table can be divided into a plurality of tables to be integrated. Furthermore, similar notation as that shown in FIG. 4 does not have to be used, and the notation may be arbitrarily changed depending on a conformation to be utilized.

On the other hand, the quantized transform coefficient 123 output from the transform/quantization unit 103 is input to the inverse quantization/inverse transform unit 104. In the inverse quantization/inverse transform unit 104, inverse quantization processing is first effected to the quantization transform coefficient 123. Here, quantization information typified by similar quantization parameter, a quantization matrix, and others as that used in the transform/quantization unit 103 is loaded from the encoding control unit 111 to be subjected to inverse quantization processing.

When the transform coefficient after the inverse quantization is subjected to inverse orthogonal transform such as inverse discrete cosine transform (IDCT), a decoded prediction error signal 126 is reproduced. The decoded prediction error signal 126 is input to the adder 106. In the adder 106, the decoded prediction error signal 126 is added to the predicted image signal 121 output from the prediction unit 101 to generate a locally decoded image signal 127.

The locally decoded image signal 127 is input to the deblocking filter unit 108 through the filtering strength changeover switch 107, subjected to deblocking filter processing by any one of a plurality of pixel filters A to D included in the filter unit 108, and then stored in the reference memory 109 as a reference image signal 131. In the deblocking filter unit 108, a deblocking skip line E that does not perform the filter processing is further provided.

Reference is made to the reference image signal 131 stored in the reference memory 109 at the time of prediction carried out by the prediction unit 101. In the reference memory 109, not only the reference image signal 131 (the locally decoded image signal after the deblocking filter processing) utilized at the time of prediction but also a coding parameter 128 used at the time of encoding in the entropy encoder 105 is also stored.

When the encoding of each target block of the input image signal 120 is completed, the coding parameter 128 which is output from the entropy encoder 105 and associated with the target block is input to the reference memory 109 via the filtering strength determination unit 110 and stored in the reference memory 109 together with the reference image signal 131 as the decoded image signal subjected to the deblocking filter processing. The coding parameter 128 is utilized at the time of filtering strength calculation for a corresponding block associated with a subsequent target block of the input image signal 120 in the locally decoded image signal 127 which should be encoded.

(Prediction Unit 101)

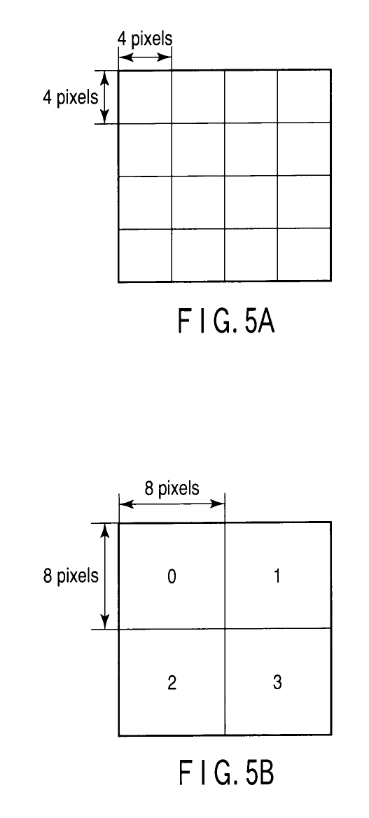

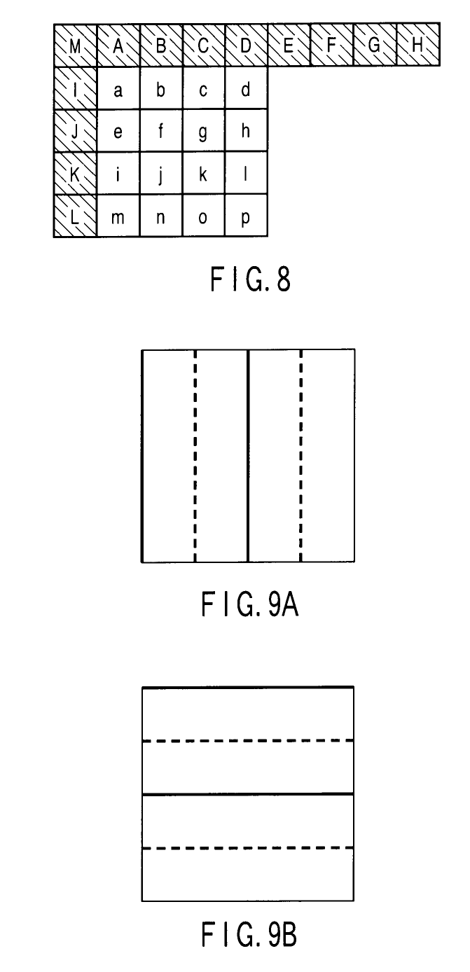

In the prediction unit 101, a pixel (a coded reference pixel) of the reference image signal 132 read from the reference memory 109 is utilized to perform the inter-prediction or the intra-prediction, whereby the predicted image signal 121 that can be selected for a target block is generated. However, in regard to a prediction mode in which the subsequent prediction cannot be effected unless the locally decoded image signal is generated in the target block like the intra-prediction in H.264 such as 4×4 pixel intra-prediction shown in FIG. 5A or 8×8 pixel intra-prediction depicted in FIG. 5B, the transform/quantization and the inverse quantization/inverse transform may be carried out in the prediction unit 101.

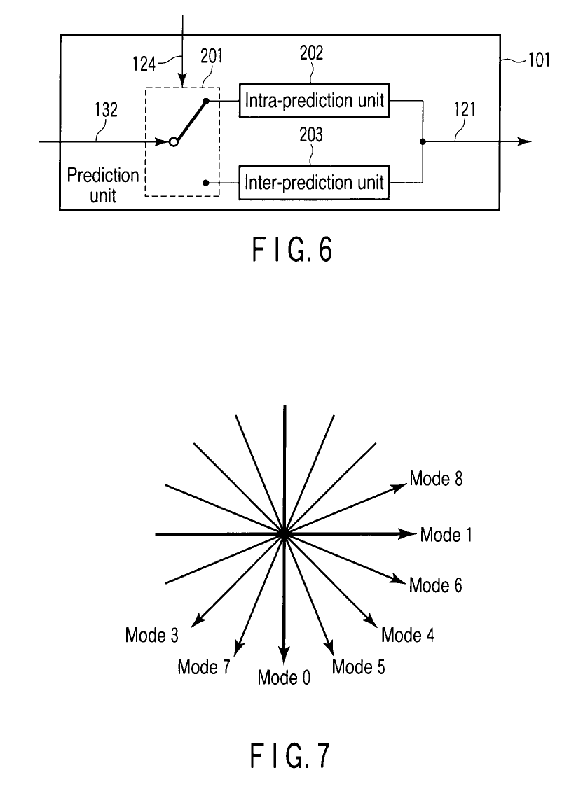

As shown in FIG. 6, the prediction unit 101 has a prediction changeover switch 201, an intra-prediction unit 202, and an inter-prediction unit 203. When the reference image signal 132 read from the reference memory 109 and the prediction information 124 from the encoding control unit 111 are input to the prediction unit 101, the prediction changeover switch 201 changes over the intra-prediction unit 202 and the inter-prediction unit 203 in response to the prediction information 124. Specifically, when a slice that is currently being coded is an intra-coded slice, the prediction changeover switch 201 leads the reference image signal 132 to the intra-prediction unit 202. On the other hand, when a slice that is currently being coded is an inter-coded slice, the prediction changeover switch 201 uses the prediction information 124 to determine one of the intra-prediction unit 202 and the inter-prediction unit 203 to which the reference image signal 132 is input. Each of the intra-prediction unit 202 and the inter-prediction unit 203 carries out the intra-prediction or the inter-prediction which will be described later to output the predicted image signal 121.

(Intra-Prediction Unit 202)

As a specific example of the intra-prediction unit 202, the intra-prediction of H.264 will be described. In the intra-prediction of H.264, the 4×4 pixel intra-prediction (see FIG. 5A), the 8×8 pixel intra-prediction (see FIG. 5B), and the 16×16 pixel intra-prediction (see FIG. 3) are defined. In the intra-prediction, the reference image signal 132 from the reference memory 109 is utilized to generate an interpolation pixel, and this pixel is copied in a spatial direction to produce a pixel value of a pixel (a predicted pixel) of the predicted image signal 121.

FIG. 7 shows prediction directions in each prediction mode of the 4×4 pixel intra-prediction. Further, FIG. 8 shows a prediction method in case of vertical prediction as a prediction mode 0. Reference characters A to M in FIG. 8 denote pixels (reference pixels) of the reference image signal 132 loaded from the reference memory 109. In the prediction mode 0, pixel values at positions of the reference pixels A, B, C, and D are simply copied in the vertical direction to generate pixel values a to p of predicted pixels. The pixel values a to p of the predicted pixels are generated based on the following expressions, respectively.

a,e,i,m=A

b,f,j,n=B

c,g,k,o=C

d,h,l,p=D (1)

According to prediction methods in prediction modes 1 to 8 other than the prediction mode 0, pixel values of predicted pixels are generated based on similar concept.

(Inter-Prediction Unit 203)

The inter-prediction unit 203 will now be described. In the inter-prediction unit 203, when predicting a target block, a plurality of coded reference pixels included in the reference image signals stored in the reference memory 109 are utilized to effect block matching. In the block matching, a shift amount (a motion vector) of each of the plurality of reference pixels from a pixel of a target block of the input image signal 120 as an original image is calculated, and this shift amount is utilized to output an image having the smallest difference from the original image in predicted images as the predicted image signal 121. This shift amount is calculated in the form of an integral pixel accuracy or a fractional pixel accuracy. When the shift amount is calculated as a fractional pixel accuracy, a corresponding reference pixel is also used to create an interpolation image in accordance with the accuracy. The calculated shift amount is added as motion vector information to the prediction information 124, also supplied to the entropy encoder 105 to be subjected to entropy encoding, and then multiplexed in encoded data. (Mode Determination/Prediction Error Calculation Unit 102)

The predicted image signal 121 generated by the prediction unit 101 is input to the mode determination/prediction error calculation unit 102. In the mode determination/prediction error calculation unit 102, an optimum prediction mode is selected (which is called a mode determination) based on the input image signal 120, the predicted image signal 121, and the prediction information 124 used in the prediction unit 101. Next, the mode determination/prediction error calculation unit 102 generates the prediction error signal 122 associated with the selected optimum prediction mode. The prediction error signal 122 is generated by subtracting the predicted image signal 121 from the input image signal 120.

Giving a more specific explanation, the mode determination/prediction error calculation unit 102 carries out the mode determination using such a cost as represented by the following expression. Assuming that a code rate concerning the prediction information 124 is OH and a sum of absolute difference between the input image signal 120 and the predicted image signal 121 (which means an absolute cumulative sum of the prediction error signal 122) is SAD, the following mode determination expression is used.

K=SAD+2λ×OH (2)

where K is a cost, and λ is a Lagrangian undetermined multiplier which is determined based on a value of a quantization scale or a quantization parameter.

The mode determination is carried out based on the thus obtained cost K. That is, a mode in which the cost K gives the smallest value is selected as the optimum prediction mode.

In the mode determination/prediction error calculation unit 102, the mode determination may be carried out by (a) using the prediction information 124 alone or (b) using SAD alone in place of Expression (2), or (c) a value obtained by performing Hadamard transform with respect to the prediction information 124 or the SAD or an approximated value of this value may be utilized. Moreover, in the mode determination/prediction error calculation unit 102, an activity (a variance of a signal value) of the input image signal 120 may be used to create a cost, or a quantization scale or a quantization parameter may be utilized to create a cost function.

Additionally, as another example, a temporary encoding unit may be prepared, and a code rate when the prediction error signal 122 generated in a given prediction mode is actually encoded by the temporary encoding unit and a square error between the input image signal 120 and the locally decoded image signal 127 or a square error between the input image signal 120 and a locally decoded image signal 131 after the deblocking filter processing may be utilized to effect the mode determination. A mode determination expression in this case is as follows.

J=D+λ×R (3)

where J is a coding cost, and D is coding distortion representing a square error between the input image signal 120 and the locally decoded image 120 or a square error between the input image signal 120 and the locally decoded image signal 131 after the deblocking filter processing. On the other hand, R denotes a code rate estimated by temporary encoding.

When the coding cost J in Expression (3) is used, the temporary encoding and the local decoding processing are required in accordance with each prediction mode, and hence a circuit scale or an arithmetic amount increases. Contrarily, since the more accurate code rate and coding distortion are utilized, a high coding efficiency can be maintained. A cost may be calculated by using R alone or D alone in place of Expression (3), or a cost function may be generated by using an approximated value of R or D.

(Deblocking Filter Unit 108)

The deblocking filter unit 108 will now be described. The deblocking filter processing means filter processing for removing block distortion which is high-frequency noise generated at a boundary between a target block and an adjacent block. The locally decoded image signal 127 output from the adder 106 is input to the filtering strength changeover switch 107. The filtering strength changeover switch 107 leads the locally decoded image signal 127 from the adder 106 to any one of the pixel filters A to D or the deblocking skip line E in order to change over the filtering strength of the deblocking filter unit 108 in accordance with filtering strength information 130 output from the filtering strength determination unit 110.

The filtering strength information 130 is called a BS value. The deblocking filter processing is carried out by leading the locally decoded image signal 127 to the pixel filter A when the BS value is 4, leading the locally decoded image signal 127 to the pixel filter B when the BS value is 3, leading the locally decoded image signal 127 to the pixel filter C when the BS value is 2, and leading the locally decoded image signal 127 to the pixel filter D when the BS value is 1, and the deblocking filter processing is prevented from being performed by leading the locally decoded image signal 127 to the deblocking skip line E when the BS value is 0.

The deblocking filter processing is applied to a block boundary of the locally decoded image signal 127. Each of FIGS. 9A and 9B shows an example where the filter processing is performed at a block boundary in a vertical direction. A solid line represents a situation where the filter processing is performed at both an 8×8 block boundary and a 4×4 block boundary, and a broken line represents a situation where the filter processing is effected at the 4×4 block boundary. Although the filter processing is first performed in the vertical direction as shown in FIG. 9A and then the filter processing is carried out in a horizontal direction as shown in FIG. 9B in this embodiment, the filter processing may be first performed in the horizontal direction and then the filter processing may be effected in the vertical direction.

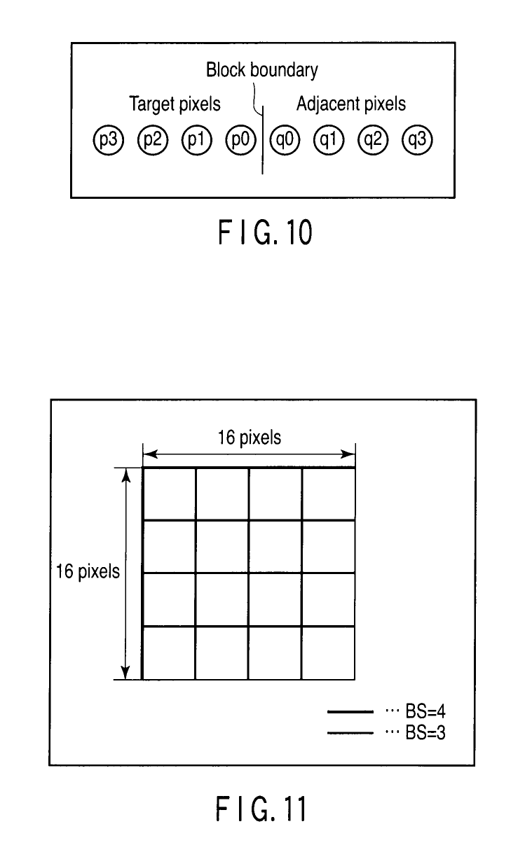

FIG. 10 shows an example of pixel arrangement to be utilized when the deblocking filter processing is carried out. Each index denoted by p in the drawing indicates a pixel of a target block (a target pixel), and each index denoted by q indicates a pixel of a block adjacent to the target block (an adjacent pixel). That is, this means that a block boundary is present between p0 and q0. Although the deblocking filter processing is carried out with respect to 8 pixels shown in FIG. 10, a pixel which is not utilized due to, e.g., a filter tap length may be limited, and filter processing using more pixels on both expanded sides may be effected.

(Filtering Strength Determination Unit 110)

FIG. 11 shows an example of filtering strength allocated to each block boundary described in FIGS. 9A and 9B. In FIG. 11, filtering strength associated with BS=4 is given to upper and left block boundaries (indicated by heavy lines) in a screen, and BS=3 is given to any other block boundaries (indicated by narrow lines). The filtering strength (a BS value) is set in accordance with each block boundary in this manner, and the deblocking filter processing is carried out by using a pixel filter associated with a set BS value.

The pixel filters A to D will now be described. The pixel filters A to D have, e.g., different filter types, tap lengths, and filter coefficients as the filter strength differs. In this embodiment, the filter A has the highest filtering strength, and the filtering strength is set to be gradually weakened in order of the filter B, the filter C, and the filter D. Therefore, selecting any one of the pixel filters A to D in accordance with the filtering strength information 130 supplied from the filtering strength determination unit 110 enables selectively changing the filtering strength adapted to a target block. However, the pixel filters A to D have different calculation amounts with differences in the filtering strength.

(Specific Example 1 of Filtering Strength Determination Unit 110: Intra-Coding)

The filtering strength determination unit 110 will now be described in detail. The filtering strength determination unit 110 has a function of receiving the coding parameter 128 of a target block used when coding the target block and a coding parameter 129 of an adjacent block adjacent to the target block stored in the reference memory 109 as inputs and determining the filtering strength of the deblocking filter processing based on the coding parameters 128 and 129.

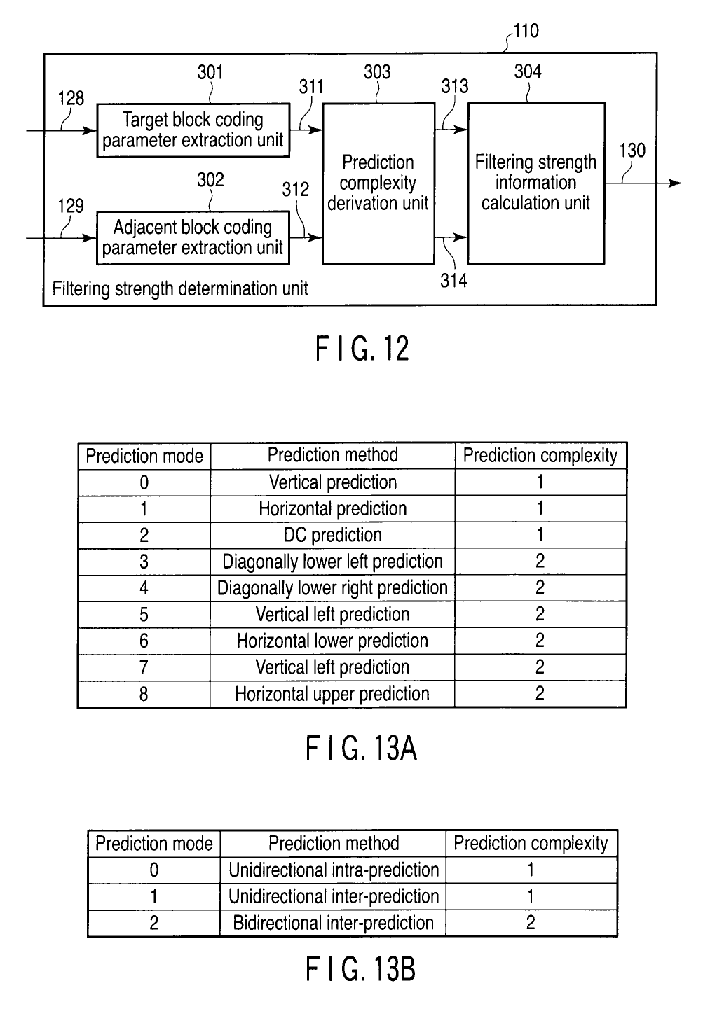

FIG. 12 shows a specific example of the filtering strength determination unit 110 in this embodiment, and this unit has a target block coding parameter extraction unit 301, an adjacent block coding parameter extraction unit 302, a prediction complexity derivation unit 303, and a filtering strength information calculation unit 304.

The target block coding parameter extraction unit 301 and the adjacent block coding parameter extraction unit 302 extract information required as prediction information 311 of a target block and prediction information 312 of an adjacent block, e.g., a prediction mode indicative of a prediction method, a prediction block index indicative of a prediction block size, and information of a block prediction order from the coding parameter 128 of the target block and the coding parameter 129 of the adjacent block which have been input thereto, respectively.

The pieces of prediction information 311 and 312 extracted by the target block coding parameter extraction unit 301 and the adjacent block coding parameter extraction unit 302 are input to the prediction complexity derivation unit 303. It is to be noted that, when the prediction information required for the target block is the same as that required for the adjacent block, the two coding parameter extraction units 301 and 302 do not necessarily have to be provided, and one of these units may be shared. Further, the pieces of information extracted by the target block coding parameter extraction unit 301 and the adjacent block coding parameter extraction unit 302 do not necessarily have to be required in relation to the prediction mode, the prediction block index, and the block prediction order, and at least one piece of information may be extracted, or another parameter that affects the prediction complexity may be extracted. Furthermore, the pieces of information extracted by the target block coding parameter extraction unit 301 and the adjacent block coding parameter extraction unit 302 may be changed in accordance with each coded slice.

Prediction information 311 of the target block output from the target block coding parameter extraction unit 301 and prediction information 312 of the adjacent block output from the adjacent block coding parameter extraction unit 302 are input to the prediction complexity derivation unit 303. The prediction complexity derivation unit 303 retains a table that is used for deriving prediction complexity indicative of a degree of complication of the prediction processing in accordance with the input pieces of prediction information 311 and 312.

FIG. 13A shows an example of a table for deriving prediction complexity from a prediction method defined in a prediction mode. Here, the prediction mode is associated with the intra-prediction of H.264 shown in FIG. 7. In the example of FIG. 13A, prediction complexity 1 is given with respect to a prediction mode 0 (vertical prediction) and a prediction mode 1 (horizontal prediction) for enabling generation of a prediction value by simply copying a pixel and a prediction mode 2 (DC prediction) for generating a prediction value by using an average value of reference pixels. As explained above, the prediction complexity represents a degree of complication of the prediction processing, and it is specifically associated with, e.g., the number of processing steps (throughputs) concerning prediction. Since the number of processing steps in each of the prediction modes 0 to 1 is 1, the prediction complexity is set to 1. Further, since prediction values in a block all take the same value in a prediction mode 2, the prediction complexity is set to 1. On the other hand, in other prediction modes 3 to 8, prediction is carried out by two steps of processing, i.e., (i) using a reference pixel to generate an interpolation pixel value and then (ii) copying a value in a prediction direction associated with FIG. 7, and hence prediction complexity 2 is given to the prediction modes 3 to 8.

FIG. 13B shows another example of a table for deriving prediction complexity from a prediction method defined in a prediction mode. In the example of FIG. 13B, a unidirectional intra-prediction, unidirectional inter-prediction, and bidirectional inter-prediction are defined in association with prediction modes. The unidirectional intra-prediction means the above-described intra-prediction of H.264. The unidirectional inter-prediction means the inter-prediction for effecting above-described block matching. The prediction complexity 1 is set with respect to the unidirectional intra-prediction and the unidirectional inter-prediction.

On the other hand, the bidirectional inter-prediction means inter-prediction for combining two types of unidirectional inter-prediction to generate a prediction value (e.g., bidirectional inter-prediction of a B-slice in H.264). In the bidirectional inter-prediction, two types of unidirectional prediction must be carried out and processing of combining respective prediction values is required as compared with the unidirectional inter-prediction, and hence this prediction has a higher degree of complication of the prediction processing than those of the unidirectional intra-prediction and the unidirectional inter-prediction. Therefore, the prediction complexity 2 is set with respect to the bidirectional prediction.

It is to be noted that “Prediction method” in each of FIGS. 13A and 13B is shown to make a relationship between itself and the prediction mode understandable, and the prediction mode and the prediction complexity alone are written and associated with each other in an actual table.

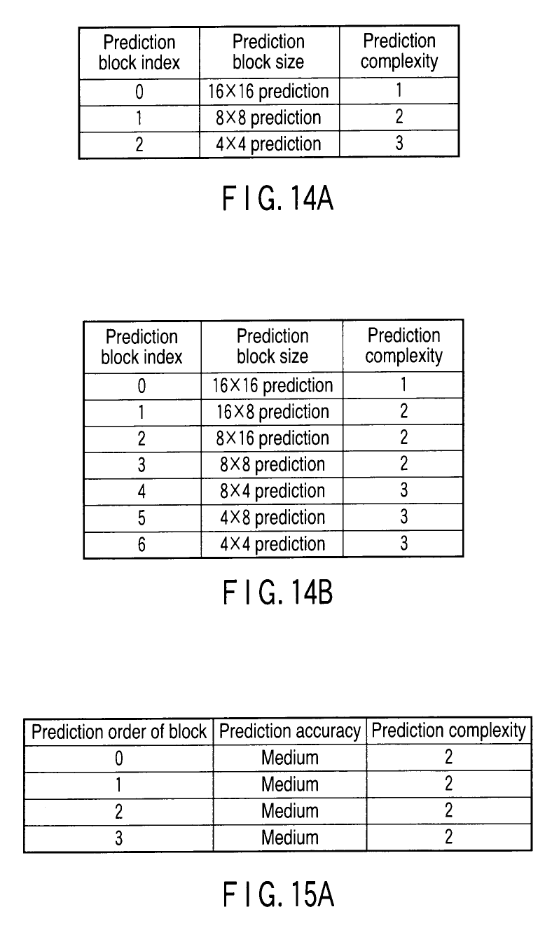

FIG. 14A shows a table for deriving prediction complexity from a size of a prediction block defined in a prediction block index. Here, as an example, prediction complexity of each of 16×16 prediction, 8×8 prediction, and 4×4 prediction as prediction block sizes of the intra-prediction defined in H.264 is set. In general, since the prediction complexity of an entire target block increases with a reduction in a prediction size, smaller complexity is set with respect to a larger prediction block size. For example, in FIG. 14A, the prediction complexity 1 is set with respect to the 16×16 prediction, the prediction complexity 2 is set with respect to the 8×8 prediction, and the prediction complexity 3 is set with respect to the 4×4 prediction.

FIG. 14B shows another example of a table for deriving prediction complexity from a size of a prediction block defined in a prediction block index. Here, as an example, prediction complexity is set with respect to each of 16×16 prediction, 16×8 prediction, 8×16 prediction, 8×8 prediction, 8×4 prediction, 4×8 prediction, and 4×4 prediction as prediction block sizes defined in the inter-prediction of H.264.

It is to be noted that “Prediction block index” in each of FIGS. 14A and 14B is shown to make a relationship between itself and the prediction block size understandable, and the prediction block index and the prediction complexity alone are written and associated with each other in an actual table.

Each of FIGS. 15A and 15B shows a table for deriving prediction complexity from a prediction accuracy defined in a block prediction order. The block prediction order indicates the alignment of block indexes depicted in FIG. 5B. For example, a prediction order 0→1→2→3 means that 8×8 pixel blocks are predicted in a raster order. On the other hand, an order 3→2→1→0 means that the 8×8 pixel blocks are predicted in an inverse raster order.

FIG. 15A shows a table of prediction complexity when the block prediction order is the raster order (0→1→2→3). As apparent from FIG. 5B, the 8×8 pixel blocks having the indexes 0 to 3 are all predicted based on extrapolation using two predicted (coded) blocks adjacent to each other (an upper adjacent block and a left adjacent block), and hence a medium prediction accuracy, i.e., the same prediction complexity 2 is set.

On the other hand, FIG. 15 shows a table of prediction complexity when the block prediction order is the inverse raster order (3→2→1→0). In case of the inverse raster order, as apparent from FIG. 5B, since the block having the index 3 is predicted based on extrapolation from non-adjacent reference pixels (an upper adjacent reference pixel of the block having the index 1 and a left adjacent reference pixel having the index 2), this block has the lowest prediction accuracy, and hence the lowest prediction complexity 1 is set. Since the block having the index 2 is predicted based on interpolation using two predicted adjacent blocks (a left adjacent block and a right adjacent block=the block having the index 3) and the block having the index 1 is likewise predicted based on interpolation using two predicted adjacent blocks (an upper adjacent block and a lower adjacent block=the block having the index 3), these blocks have a higher prediction accuracy than the block having the index 3, and hence the higher prediction complexity 2 is set. Since the block having the index 0 is predicted based on interpolation using four surrounding blocks (a left adjacent block, an upper adjacent block, a lower adjacent block=the block having the index 2, and a right adjacent block=the block having the index 1), this block has the highest prediction accuracy, and hence the highest prediction complexity 3 is set.

It is to be noted that “Prediction accuracy” in each of FIGS. 15A and 15B is shown to make a relationship between itself and the block prediction order understandable, and the block prediction order and the prediction complexity alone are written and associated with each other in an actual table.

The pieces of prediction complexity information 313 and 314 indicative of the prediction complexity of the target block and the prediction complexity of the adjacent block derived by the prediction complexity derivation unit 303 are input to the filtering strength information calculation unit 304. The filtering strength information calculation unit 304 calculates all the pieces of filtering strength information 130 associated with the block boundaries of the target block based on the pieces of input prediction complexity information 313 and 314.

A specific calculation method in the filtering strength information calculation unit 304 will now be described. First, the lowest prediction complexity value is calculated from the input pieces of prediction complexity information 313 and 314 based on the following expression.

Comp_{—}X=min(Comp_{—}A,Comp_{—}B,Comp_{—}C) (4)

where Comp_A is prediction complexity associated with a prediction mode, Comp_B is prediction complexity associated with a prediction block size, and Comp_C is prediction complexity associated with a prediction order. Comp_X represents prediction complexity Comp_T of a target block or prediction complexity Comp_N of an adjacent block. min(A,B,C) is a function for returning a variable that gives the smallest value in variables A, B, and C.

Then, the prediction complexity at a block boundary is calculated by using the following expression.

Comp=min(Comp_{—}T,Comp_{—}N) (5)

where Comp represents prediction complexity finally allocated to a corresponding block boundary.

A BS value as filtering strength is calculated with respect to the finally obtained prediction complexity of the corresponding block boundary by using the following expression.

BS=MAX_{—}BS−Comp (6)

where MAX_BS represents a maximum value of the filtering strength, and it is MAX_BS=4 in this embodiment.

The calculations shown in Expressions (4), (5), and (6) are performed at all block boundaries to which the filter processing is performed, thereby calculating the filtering strength information 130. min(A,B,C) in Expressions (4) and (5) may be changed to a function max(A,B,C) that returns maximum values of the variables A, B, and C, or a median value may be taken. Selection criteria in this example are adopted within the same framework as that of a later-explained image decoding apparatus.

The above has described the example of deriving the prediction complexity from (a) the prediction mode indicative of the prediction method, (b) the prediction block index indicative of the prediction block size, and (c) the block prediction order indicative of the prediction accuracy as explained in conjunction with FIGS. 13A, 13B, 14A, 14B, 15A, and 15B. However, these three items do not have to be necessarily used for deriving the prediction complexity, and any one of (a), (b), and (c) may be used to derive the prediction complexity, or at least two of (a), (b), and (c) may be combined to create one table. In this case, Comp N (N denotes one of A, B, and C) shown in Expression (4) should be initialized by using, e.g., MAX_BS.

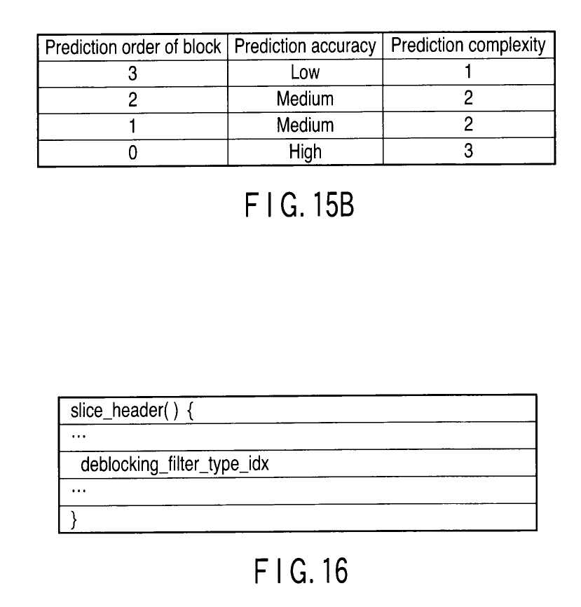

FIG. 16 shows an example of changing a method for deriving the prediction complexity in accordance with a coded sequence, a coded picture, and a coded slice. FIG. 16 shows an example where an index deblocking_filter_type_idc as a flag that can change a filtering strength determination method in the deblocking filter processing is transmitted by using a slice header. As described in conjunction with, e.g., FIGS. 13A, 13B, 14A, 14B, 15A, and 15B, this index deblocking_filter_type_idc can change one of (a) the prediction mode indicative of a prediction method, (b) the prediction block index indicative of a prediction block size, and (c) a block prediction order indicative of a prediction accuracy to be utilized to calculate the prediction complexity. For example, in advance, FIG. 13A or FIG. 13B alone, which is a table for deriving the prediction mode indicative of a prediction method, is utilized to allocate a type for determining the prediction complexity as deblocking_filter_type_idc=0, and FIG. 15A or FIG. 15B showing a block prediction order indicative of a prediction accuracy is utilized to allocate a type for determining the prediction complexity as deblocking_filter_type_idc=1. When such allocation is changed for each slice, the filtering strength determination method can be changed in accordance with characteristics of each slice.

(Specific Example 1 of Filtering Strength Determination Unit 110: Intra-Coding)

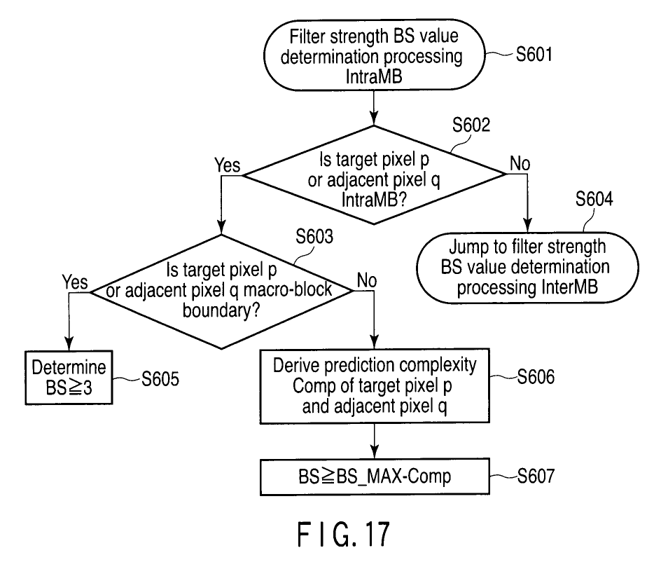

Processing of the filtering strength determination unit 110 will now be described with reference to FIG. 17. The filtering strength determination unit 110 determines filtering strength at block boundaries in both the vertical direction and the horizontal direction required for the deblocking filter processing carried out at the block boundaries (a step S601). The filtering strength is determined at all block boundaries placed at block boundaries in FIG. 9A or 9B to which the deblocking filter processing is performed. However, when a corresponding block boundary is an image boundary, the deblocking filter processing does not have to be carried out.

First, whether a target pixel p and an adjacent pixel q at target block boundaries are pixels included in an intra-macro block, i.e., whether these pixels have been intra-coded is determined (a step S602).

Here, when a determination result at the step S602 is No, since both the target block boundaries have been inter-coded, the processing jumps to a filtering strength (BS value) determination processing inter-macro block (a step S604). Here, the determination on the inter-macro block filtering strength is made under other conditions that are not disclosed in this embodiment.

On the other hand, when the determination result at the step S602 is Yes, since the target pixel p or the adjacent pixel q has been intra-coded, whether the corresponding block boundary is a macro block boundary is determined (a step S603). When a determination result at the step S603 is Yes, the filtering strength determination unit 110 sets the filtering strength at the corresponding block boundary to “high” (BS≧3). Here, BS≧3 means that the BS value can possibly take a value that is equal to or above 3, and BS=3 or BS=4 is determined under other conditions that are not disclosed here. Thereafter, it is determined that an expression including such an inequality represents a range which can be determined by using conditions that are not disclosed in this embodiment.

That is, when the determination result at the step S603 is Yes, the filtering strength information 130 output from the filtering strength determination unit 110 is supplied to the filtering strength changeover switch 107, and the locally decoded image signal 127 output from the adder 106 is input to the filter B (BS=3) or the filter A (BS=4) (a step S605).

When the determination result at the step S603 is No, i.e., when the target pixel p and the adjacent pixel q are not the macro block boundaries, Expression (4) is used for calculating the prediction complexity of each target block boundary (a step S606), and then Expressions (5) and (6) are utilized to calculate the BS value (a step S607).

When the BS value obtained by Expression (6) is 4, the filtering strength information 130 of BS=4 is supplied to the filtering strength changeover switch 107 from the filtering strength determination unit 110, and the locally decoded image signal 127 is input to the filter A.

When the BS value is 3, the filtering strength information 130 of BS=3 is supplied to the filtering strength changeover switch 107 from the filtering strength determination unit 110, and the locally decoded image signal 127 is input to the filter B.

When the BS value is 2, the filtering strength information 130 of BS=2 is supplied to the filtering strength changeover switch 107 from the filtering strength determination unit 110, and the locally decoded image signal 127 is input to the filter C.

When the BS value is 1, the filtering strength information 130 of BS=1 is supplied to the filtering strength changeover switch 107 from the filtering strength determination unit 110, and the locally decoded image signal 127 is input to the filter D.

When the BS value is 0, the filtering strength information 130 of BS=0 is supplied to the filtering strength changeover switch 107 from the filtering strength determination unit 110, and the locally decoded image signal 127 is input to the deblocking skip line E.

(Specific Example 2 of Filtering Strength Determination Unit 110: Simple Determination)

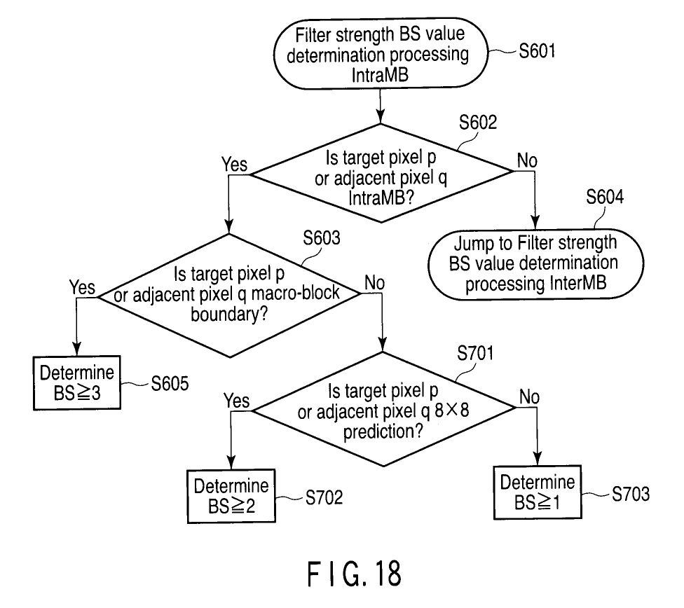

A method obtained by simplifying the filtering strength determination procedure shown in FIG. 17 will now be described with reference to FIG. 18. In FIG. 18 similar reference numerals as those in FIG. 17 denote similar processing steps as those in FIG. 17 to omit an explanation thereof.

As shown in FIG. 18, when the determination result at the step S603 is No, whether the target pixel p or the adjacent pixel q is subjected to the 8×8 prediction is determined (a step S701). Here, when a determination result at the step S701 is Yes, the filtering strength information 130 of BS=2 is supplied to the filtering strength changeover switch 107 from the filtering strength determination unit 110, and the locally decoded image signal 127 is input to the filter C. On the other hand, when the determination result at the step S701 is No, the filtering strength information 130 of BS=1 is supplied to the filtering strength changeover switch 107 from the filtering strength determination unit 110, and the locally decoded image signal 127 is input to the filter D.

(Specific Example 3 of Filtering Strength Determination Unit 110: Boundary Determination is Put Off)

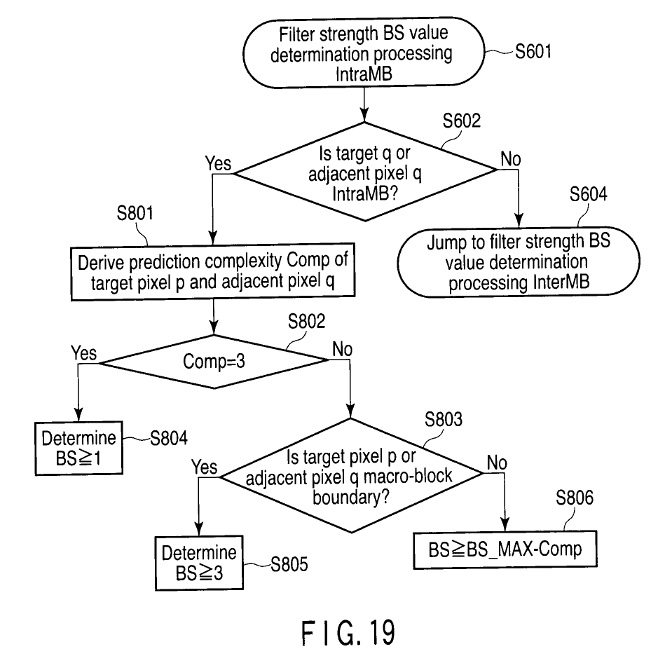

A filtering strength determination method when the processing at the step S603 and the processing at the step S606 are counterchanged with respect to the filtering strength determination procedure depicted in FIG. 17 will now be described with reference to FIG. 19. In FIG. 19, similar reference numerals as those in FIG. 17 denote similar processing steps as those in FIG. 17 to omit an explanation thereof.

As shown in FIG. 19, when the determination result at the step S602 is Yes, Expression (4) is utilized to calculate the prediction complexity at the target block boundary of the target pixel p or the adjacent pixel q (a step S801). Moreover, Expressions (5) and (6) are utilized to calculate the prediction complexity at the corresponding block boundary. Whether the prediction complexity calculated here is Comp_Th is determined (a step S802). It is to be noted that Comp_Th=3.

When a determination result at the step S802 is Yes, the filtering strength information 130 of BS=1 is supplied to the filtering strength changeover switch 107 from the filtering strength determination unit 110, and the locally decoded image signal 127 is input to the filter D (a step S804). On the other hand, when the determination result at the step S802 is No, whether the target pixel p or the adjacent pixel q corresponds to a macro block boundary is determined (a step S803).

When the determination result at the step S803 is Yes, the filtering strength information 130 of BS=3 is supplied to the filtering strength changeover switch 107 from the filtering strength determination unit 110, and the locally decoded image signal 127 is input to the filter B (a step S805). On the other hand, when the determination result at the step S803 is No, the filtering strength information 130 is calculated by using Expression (6) (a step S806).

As explained above, according to the first embodiment, the filtering strength in the deblocking filter processing is appropriately controlled based on the prediction complexity. As a result, an image quality difference between an original image and a decoded image can be prevented from increasing at a block boundary due to execution of excessive deblocking filter processing. Therefore, the coding efficiency can be improved and the subjective image quality are improved.

### Second Embodiment

A second embodiment according to the present invention will now be described. Although a configuration of an image encoding apparatus according to the second embodiment is the similar to that according to the first embodiment, an intra-prediction unit 202 of a prediction unit 101 in FIG. 6 is different from that in the first embodiment, whereby a filtering strength determination unit 110 is also different from that in the first embodiment.

(Intra-Prediction Unit 202)

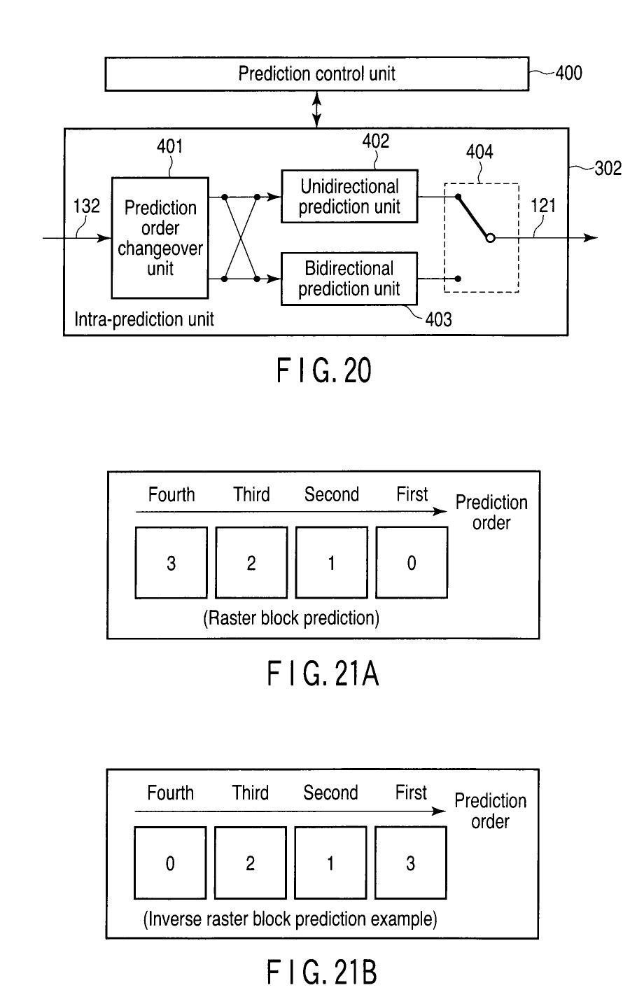

FIG. 20 shows an intra-prediction unit 202 in FIG. 6 based on the second embodiment, and it has a prediction order changeover unit 401, a unidirectional prediction unit 402, a bidirectional prediction unit 403, and a prediction changeover switch 404. As explained above, in this embodiment, the unidirectional prediction unit 402 and the bidirectional prediction unit 403 are provided as prediction units having different prediction methods.

The prediction order changeover unit 401 has a function of changing over a prediction order concerning sub-blocks in a macro block. That is, the prediction order changeover unit 401 selects a prediction order for a plurality of sub-blocks obtained by dividing a pixel block (a macro block) from a plurality of predetermined prediction orders. A reference image signal 132 whose prediction order has been changed by the prediction order changeover unit 401 is input to the unidirectional prediction unit 402 and the bidirectional prediction unit 403.

Each of the unidirectional prediction unit 402 and the bidirectional prediction unit 403 makes reference to a coded pixel to predict the macro block in accordance with the prediction order changed over and selected by the prediction order changeover unit 401 and each selected prediction mode in order to generate a predicted image signal associated with the macro block. That is, the unidirectional prediction unit 402 makes reference to the reference image signal 132 input through the prediction order changeover unit 401 based on the prediction mode directed by a prediction control unit 400 controlled by the encoding control unit 111, thereby generating a predicted image signal. The bidirectional prediction unit 403 likewise makes reference to the reference image signal 132 input through the prediction order changeover unit 401 based on the prediction mode directed by the prediction control unit 400 controlled by the encoding control unit 111, thereby generating a predicted image signal. The predicted image signals output from the unidirectional prediction unit 402 and the bidirectional prediction unit 403 are input to the prediction changeover switch 404.

The prediction changeover switch 404 selects one of the predicted image signal generated by the unidirectional prediction unit 402 and the predicted image signal generated by the bidirectional prediction unit 403 in accordance with the prediction mode directed by the prediction control unit 400 controlled by the encoding control unit 111, whereby the selected predicted image signal 121 is output. In other words, the prediction changeover switch 404 selects the number of available prediction modes from a plurality of predetermined prediction modes.

An operation of the prediction order changeover unit 401 will now be described with reference to FIGS. 21A and 21B. FIG. 5B shows a division example of 8×8 pixel blocks, and indexes shown in the respective blocks denote block indexes (idx) in a raster scan order. On the other hand, each of FIGS. 21A and 21B shows a prediction order of sub-blocks (8×8 pixel blocks) in a macro block in the 8×8 pixel intra-prediction. Raster block prediction shown in FIG. 21A represents that respective 8×8 pixel blocks in a macro block are predicted in a raster order, and inverse raster block prediction shown in FIG. 21B represents that blocks are predicted in an order of block indexes 3, 1, 2 and 0 (this prediction block will be referred to as inverse raster block prediction and this prediction order will be referred to as an inverse raster order hereinafter).

Although an example of 4×4 pixel blocks is not shown in this embodiment, a macro block is divided as shown in FIG. 5A like the example of the 8×8 pixel blocks, then a raster block prediction order in 8×8 pixel blocks is given in case of the raster block prediction, and a raster order is given with respect to four 4×4 pixel blocks in an 8×8 pixel block. On the other hand, in regard to an inverse raster order, a raster block prediction order in 8×8 pixel blocks is given, and an inverse raster order is given with respect to four pixel blocks in an 8×8 pixel block.

The above is the description on the operation of switching the prediction order effected in the prediction order changeover unit 401 and switching the input image signal 120. Although a prediction method for one 8×8 pixel block concerning the intra-prediction of 4×4 pixels will now be described, the intra-prediction of another 8×8 pixel block for 4×4 pixels and the intra-prediction for 8×8 pixels can be carried out in accordance with similar procedure.

When the inverse raster block prediction is carried out, there is provided a prediction order that one diagonal block in sub-blocks representing four 8×8 pixel blocks is first predicted based on extrapolation and remaining three blocks are predicted based on extrapolation or interpolation. The prediction based on such a prediction order will be referred to as interpolative/extrapolative prediction hereinafter. Processing by the unidirectional prediction unit 402 and the bidirectional prediction unit 403 associated with the prediction order will now be described.

(Example of Unidirectional Prediction in Case of Raster Block Prediction)

When the raster block prediction is set in the encoding control unit 111 and the prediction mode is unidirectional prediction, the unidirectional prediction unit 402 generates a predicted image signal 121 by the same prediction method as the method described as an example of H.264 as shown in FIGS. 7 and 8.

(Example of Bidirectional Prediction in Case of Raster Block Prediction)

A description will now be given as to a situation where the raster block prediction is set in the encoding control unit 111 and the prediction mode is bidirectional prediction. The bidirectional prediction unit 403 has a function of combining two predicted image signals generated by the unidirectional prediction to generate a predicted image signal. That is, assuming that a prediction value of a first unidirectional predicted image signal is P1 and a prediction value of a second unidirectional predicted image signal is P2, a predicted image signal is generated by using the following expression.

PX=W×P1+(1−W)×P2 (7)

where PX represents a predicted image signal of a prediction target block. Further, W represents a filter coefficient when combining two predicted image signals. Although W is ½ in this embodiment, it takes an actual number of 0 to 1. Although Expression (7) shows an example of generating a predicted image signal based on a real number calculation, this signal can be also readily generated by an integer calculation by defining calculation accuracy in advance. The predicted image signal generated as the unidirectional prediction is generated by the same prediction method as the method described as an example of H.264 as shown in FIGS. 7 and 8.

(Example of Unidirectional Prediction in Case of Inverse Raster Block Prediction)

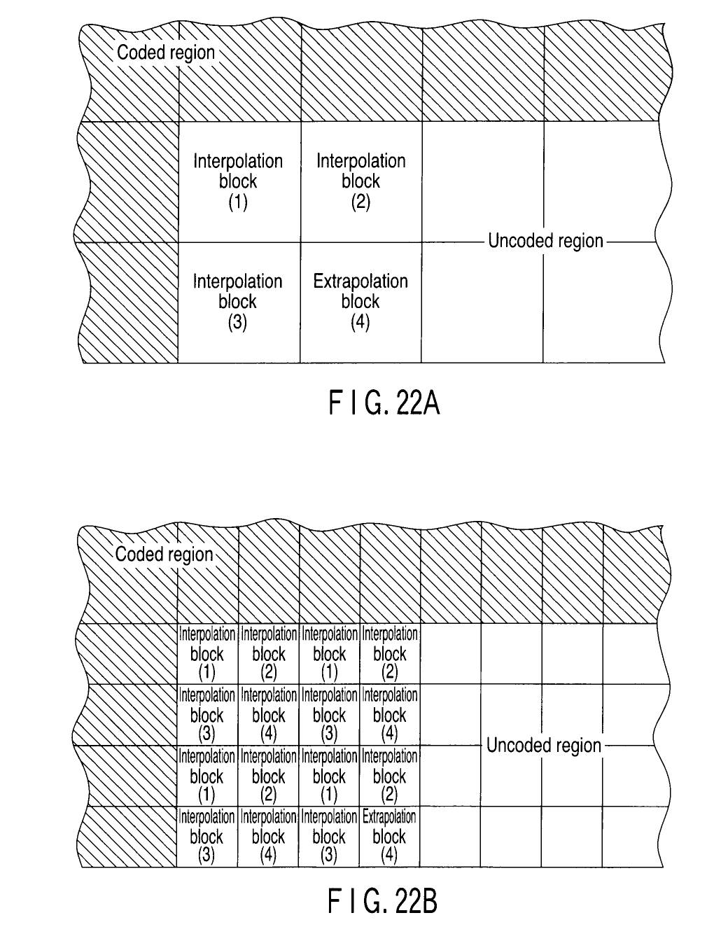

A description will now be given as to a situation where the inverse raster block prediction has been set in the encoding control unit 111 and the prediction mode is the unidirectional prediction. In such interpolation/extrapolation block prediction as explained in FIG. 21A, an order of respective sub-blocks in a macro block is changed to a prediction order based on the inverse raster block prediction from that based on the raster block prediction. For example, when predicting an 8×8 pixel block, as shown in FIG. 22A, one block at an outside corner is first predicted as a block that can be subjected to extrapolative prediction (which will be referred to as an extrapolation block hereinafter), and other three blocks are then predicted as blocks that can be subjected to interpolative prediction (which will be referred to as interpolation blocks hereinafter). That is, the extrapolation block (4) is first predicted, and then the interpolation blocks (2), (3), and (1) are predicted. On the other hand, when predicting a 4×4 pixel block, a prediction order is set by performing extrapolation block prediction and interpolation block prediction with respect to each 4×4 pixel block in units of 8×8 pixel block as shown in FIG. 22B.

The prediction processing in units of 8×8 pixel block when the 4×4 pixel prediction is selected will now be described. In this prediction processing, when the prediction in units of 8×8 pixel block is terminated, a subsequent 8×8 pixel block is performed, namely, the prediction in units of 8×8 pixel block is repeated for four times.

(Extrapolation Block Prediction)

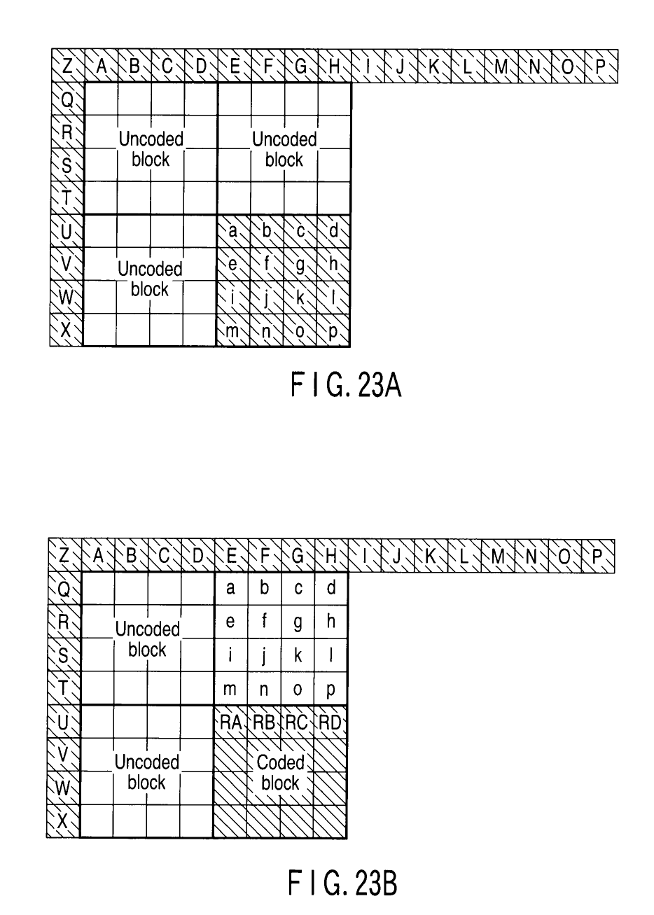

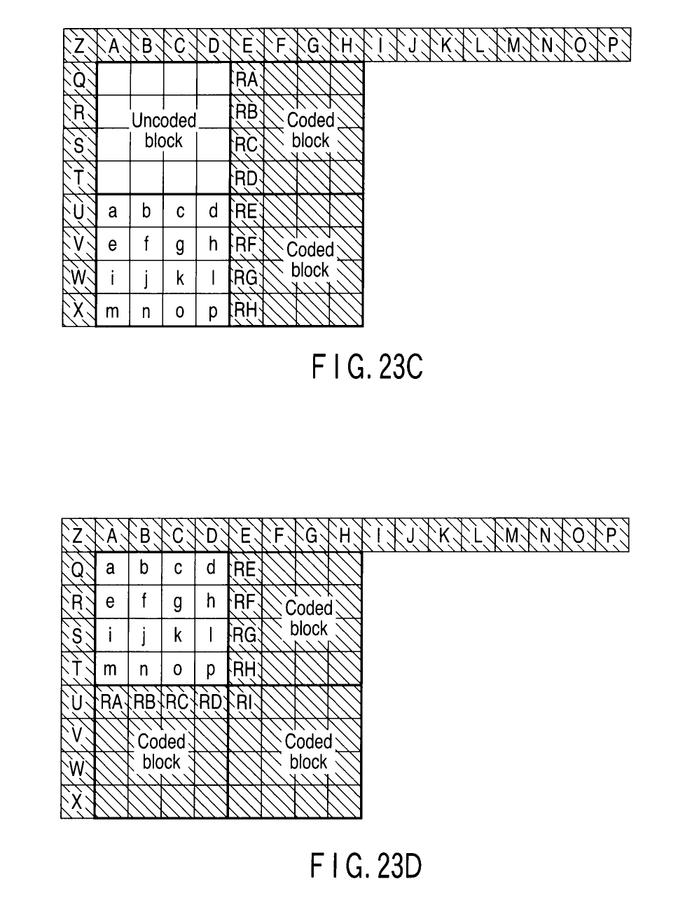

When predicting an extrapolation block, since reference pixels are distanced from predicted pixels, a range of the reference pixels is as shown in FIG. 23A. In FIG. 23A, pixels A to X and Z are reference pixels, and pixels a to p are predicted pixels. Although the range of the reference pixels is expanded, a technique of copying the reference pixels in accordance with a prediction angle to generate a predicted image signal is similar as that in the above-described raster block prediction. Specifically, a predicted image signal generation method when a mode 0 (vertical prediction) is selected is as represented by the following expression.

a,e,i,m=E

b,f,j,n=F

c,g,k,o=G

d,h,l,p=H (8)

This mode 0 can be selected only when the reference pixels E to H can be used. In the mode 0, when the reference pixels E to H are copied to the predicted pixels aligned in the vertical direction as they are, a predicted image signal is generated.

(Interpolation Block Prediction)

In FIGS. 22A and 22B, when predicting the interpolation block (2), since the prediction of the extrapolation block (4) has been terminated, the prediction making reference to pixels in the extrapolation block (4) can be performed. When predicting the interpolation block (3), reference can be made to pixels in the interpolation block (2) in addition to the extrapolation block (4). When predicting the extrapolation block (1), reference can be made to pixels in the interpolation block (3) in addition to the extrapolation block (4) and the interpolation block (2).

Each of FIGS. 23B, 23C, and 23D shows a relationship between the interpolation blocks (1), (2), and (3) and the reference pixels in the 4×4 pixel prediction. Pixels RA to RI are reference pixels newly added to FIG. 23A, and pixels a to p are predicted pixels.

(Processing of Unidirectional Prediction Unit 402 in Interpolation Block Prediction)

The unidirectional prediction unit 402 has a total of 17 modes of directional prediction in extrapolation blocks and inverse extrapolative prediction for making reference to reference pixels in a coded macro block in regard to the interpolation block prediction as shown in FIG. 25, and the 17 modes except a mode 2 have prediction directions shifted in increments of 22.5 degrees. Inverse prediction modes are added to prediction modes of the extrapolation block prediction (sequential block prediction) shown in FIG. 7. That is, respective modes of the vertical prediction, the horizontal prediction, the DC prediction, the diagonally lower left prediction, the diagonally lower right prediction, the vertical right prediction, the horizontal lower prediction, the vertical left prediction, and the horizontal upper prediction are also used in FIGS. 7 and 25 in common.

On the other hand, in FIG. 25, the inverse vertical prediction (a mode 9), the inverse horizontal prediction (a mode 10), the diagonally upper right prediction (a mode 11), the diagonally upper left prediction (a mode 12), the inverse vertical left prediction (a mode 13), the inverse horizontal upper prediction (a mode 14), the inverse vertical right prediction (a mode 15), and the inverse horizontal lower prediction (a mode 16) are added to the modes depicted in FIG. 7.

Whether the prediction mode can be selected is determined based on a positional relationship of the reference pixels with respect to the interpolation block and presence/absence of the reference pixels shown in FIGS. 22A and 22B. For example, in the interpolation block (1), since the reference pixels are arranged in all of left, right, upper, and lower directions, all modes 0 to 16 can be selected as depicted in FIG. 25. On the other hand, in the interpolation block (2), since the reference pixels are not arranged on the right-hand side, the mode 10, the mode 14, and the mode 16 cannot be selected. In the interpolation block (3), since the reference pixels are not arranged on the lower side, the mode 9, the mode 13, and the mode 15 cannot be selected.

A description will now be given as to a predicted image signal generation method of the unidirectional prediction unit 402 in the interpolation block prediction in case of the inverse raster block prediction. Specifically, when the mode 9 (the inverse vertical prediction) is selected, a predicted image signal is generated from the reference pixels placed at the nearest positions in the lower direction. In regard to each of the interpolation block (1) and the interpolation block (2), the predicted image signal is calculated in accordance with the following expression.

a,e,i,m=RA

b,f,j,n=RB

c,g,k,o=RC

d,h,l,p=RD (9)

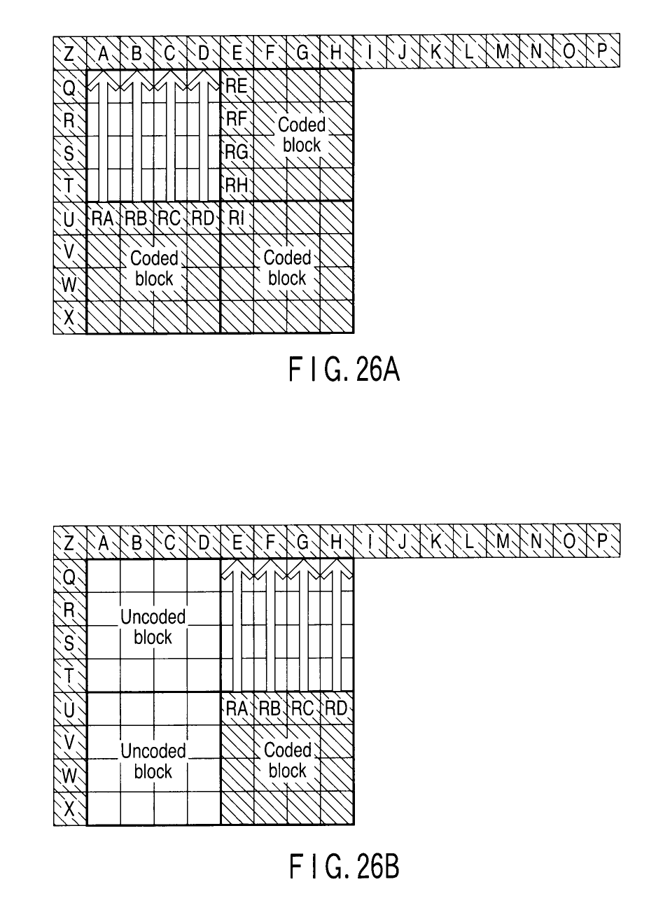

Each of FIGS. 26A and 26B shows a method for generating a predicted image signal with respect to the interpolation block (1) and the interpolation block (2) in the mode 9. When the reference pixels RA to RD are copied to predicted pixels aligned in the vertical directions as they are, the predicted image signal is generated. In regard to the interpolation block (3), since the reference pixels are not present in the lower direction, the mode 9 cannot be utilized.

In relation to prediction modes other than the mode 9, a prediction method for copying a predicted image signal interpolated from the nearest pixels to which reference can be made in each prediction direction depicted in FIG. 25 is used. When the reference pixels are not arranged in the prediction direction, values of the nearest reference pixels may be copied to generate and utilize the reference pixels, or virtual reference pixels may be generated from the interpolation of the plurality of reference pixels and the virtual reference pixels may be utilized for the prediction.

(Example of Bidirectional Prediction in Case of Inverse Raster Block Prediction)

A description will now be given as to a case that the inverse raster block prediction is set in the encoding control unit 111 and the prediction mode is the bidirectional prediction. The bidirectional prediction unit 403 has a function of combining two predicted image signals generated by the unidirectional prediction based on the inverse raster block prediction to generate a predicted image signal. That is, Expression (7) is utilized to generate the predicted image signal of the bidirectional prediction. The predicted image signal generated as the unidirectional prediction means the predicted image signal 121 generated in accordance with a prediction mode indicated by each block index as shown in FIG. 25.

As explained above, the intra-prediction unit 302 in FIG. 20 includes the unidirectional prediction unit 402 and the bidirectional prediction unit 403 as the prediction units having different prediction methods and also includes the raster block prediction and the inverse raster block prediction as the prediction methods having different prediction orders. Additionally, as a combination of these types of prediction, there is a concept called an extrapolation block and an interpolation/extrapolation block.

(Filtering Strength Determination Unit 110)

In this embodiment, a determination technique of the filtering strength determination unit 110 varies with a change in the prediction unit 101. The filtering strength determination unit 110 in this embodiment will now be described. A configuration of the filtering strength determination unit 110 in this embodiment is the similar to that in FIG. 12. However, a prediction complexity derivation table set in the prediction complexity derivation unit 303 is different.

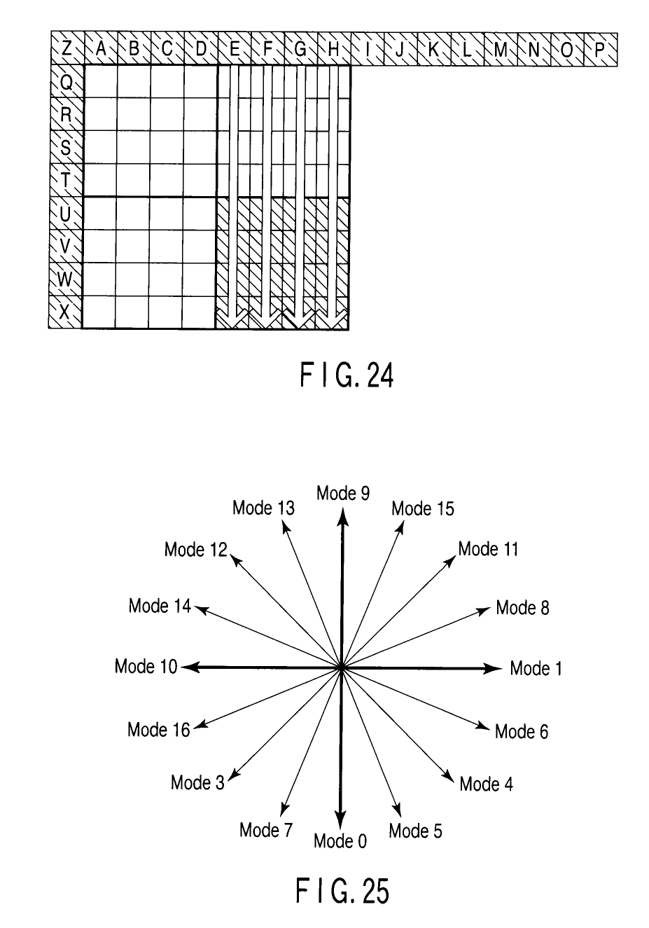

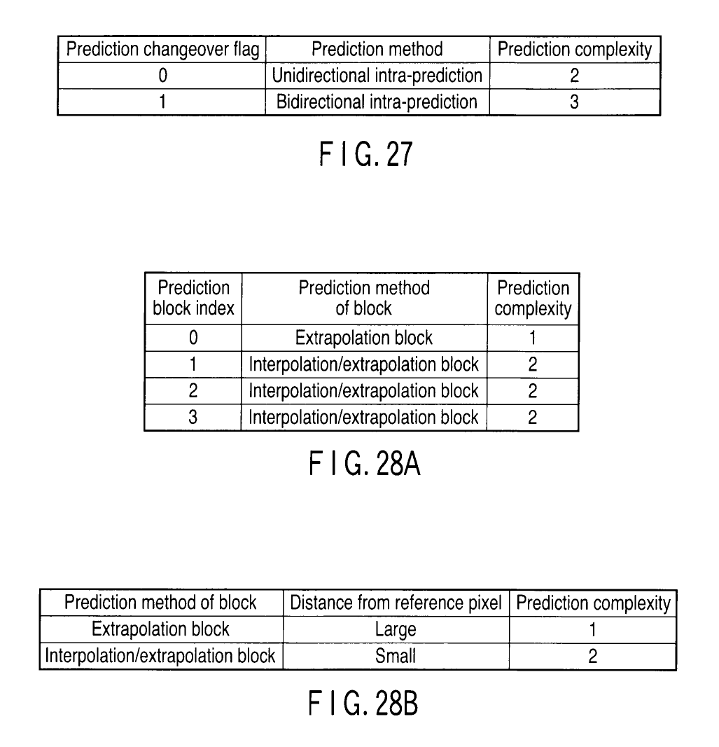

FIG. 27 shows an example of the prediction complexity derivation table concerning the prediction method of the intra-prediction in this embodiment. The prediction complexity is high for the bidirectional intra-prediction which has higher prediction complexity than the unidirectional intra-prediction. As explained in conjunction with FIGS. 24, 25, 26A, and 26B, the unidirectional intra-prediction utilizes the prediction method of copying reference pixel values or pixel values obtained by interpolating the reference pixel values in a prediction direction. On the other hand, in the bidirectional prediction, filtering a predicted image signal generated by the unidirectional prediction enables generating a new predicted image signal. Since the deblocking filter processing is carried out with respect to a block boundary of the locally decoded image signal 127 generated by adding the predicted image signal 121 to the prediction error signal 126, the prediction complexity is set high with respect to the bidirectional prediction in which the filter processing is applied when generating the predicted image signal as compared with the unidirectional prediction. Consequently, this processing is equal to setting the low filtering strength. Setting the prediction complexity in this manner enables preventing the deblocking processing from being excessively carried out with respect to block boundaries.

FIG. 28A shows a prediction complexity derivation table concerning a block prediction method in case of the inverse raster block prediction in an 8×8 pixel block of the intra-prediction according to this embodiment. As shown in FIG. 22A, in accordance with a prediction order, an index 0 (an index of a block that is predicted first) alone is associated with an extrapolation block and other three blocks are associated with interpolation/extrapolation blocks. In regard to the extrapolation block, substantially the same prediction method as H.264 is adopted, and hence the prediction complexity is set to be higher than those of the interpolation/extrapolation blocks that the interpolative prediction can be used. Here, in the extrapolation block, since a distance from each reference pixel to a predicted pixel is long, reflecting spatial properties of an image in a prediction value is difficult. That is, the extrapolation block has a possibility that the prediction error signal 122 as a difference between the input image signal 120 and the predicted image signal 121 becomes large, and distortion at a block boundary tends to increase. Thus, in relation to the extrapolation block, the prediction complexity is set to be lower than those of the interpolation/extrapolation blocks, whereby the filtering strength of the deblocking filter is set to be rather high.

FIG. 28B shows a prediction complexity derivation table concerning a block prediction method and a distance from each reference pixel in the inverse raster block prediction in an 8×8 pixel block of the intra-prediction according to this embodiment. In the inverse raster block prediction, as already explained in conjunction with FIGS. 23A and 23B, a distance from the reference pixel that can be used in each sub-block is different. In an extrapolation block, since the interpolative prediction cannot be utilized as described above, the complexity is set to be lower than that of an interpolation/extrapolation block.

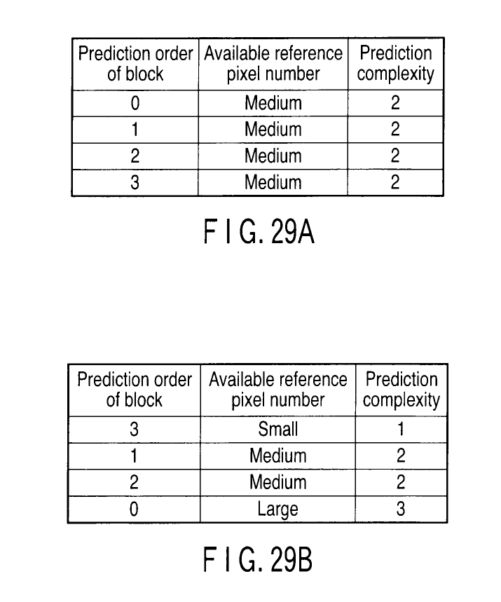

Each of FIGS. 29A and 29B shows a prediction complexity derivation table concerning each block index and the number of reference pixels in an 8×8 pixel block of the intra-prediction according to this embodiment. FIG. 29A shows an example of the raster block prediction, and FIG. 29B shows an example of the inverse raster block prediction. In FIG. 29A, since the number of reference pixels that can be used in accordance with each block index is not greatly different, the prediction complexity is similar in all blocks. On the other hand, in the inverse raster block prediction shown in FIG. 29B, as explained in conjunction with FIGS. 23A, 23B, 23C, and 23D, the number of reference pixels that can be used in each sub-block differs. Since the number of pixels that can be used in a prediction expression when the number of reference pixels is small is reduced to be smaller than that when more reference pixels can be utilized, the prediction complexity is low. That is, when the prediction order varies, the number of available reference pixels is changed, and a direction along which the prediction can be performed is also changed. As a result, there arise tendencies, i.e., a block that is easy to be predicted and a block that is difficult to be predicted depending on each prediction order. Thus, to increase the filtering strength of the block that is difficult to be predicted, such a prediction complexity table is set.

It is to be noted that each of FIGS. 28A, 28B, 29A, and 29B shows an example of the intra-prediction of an 8×8 pixel block, but similar technique can be utilized to create a prediction complexity derivation table for the intra-prediction of a 4×4 pixel block.

In the prediction complexity derivation unit 303 in FIG. 12, the above-described prediction complexity derivation table and Expression (4) are utilized to derive the prediction complexity information 313 of a target block and the prediction complexity information 314 of an adjacent block. When both the pieces of prediction complexity information 313 and 314 are input to the filtering strength information calculation unit 304, the final filtering strength information 130 (a BS value) at a corresponding block boundary is calculated by using Expressions (5) and (6). Thereafter, a procedure that the calculated filtering strength information 130 is utilized to effect the filter processing is similar as the flow described in the first embodiment.

(First Specific Example of Filtering Strength Determination Method)

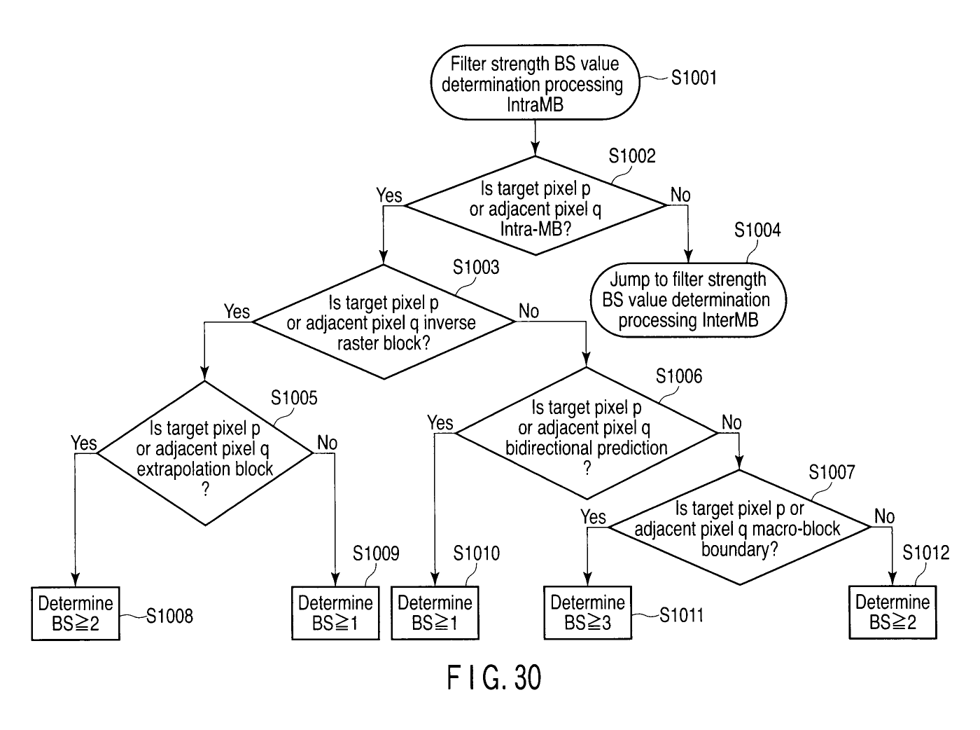

A first specific example of the filtering strength determination method in the second embodiment, specially a determination technique when determining the filtering strength will now be described with reference to FIG. 30.

The filtering strength determination unit 110 determines the filtering strength at each of both block boundaries in the vertical and horizontal directions required for the deblocking filter processing that is carried out at the block boundaries (a step S1001). The filtering strength is determined at all block boundaries placed at block boundaries in FIGS. 9A and 9B where the deblocking filter processing is effected. However, when a corresponding block boundary is a boundary of the image, the deblocking filter processing does not have to be carried out.

First, whether pixels p and q at target block boundaries have been intra-coded is determined (a step S1002). Information concerning a coding mode is based on a coding parameter 128 of a target block output from an entropy encoder 105 and a coding parameter 129 of an adjacent block read out from a reference memory 109.

Here, when a determination result at the step S1002 is No, both the target block boundaries have been inter-coded, and hence the processing jumps to a filtering strength (BS value) determination processing inter-macro block (a step S1004). Here, the filtering strength of the inter-macro block is determined under other conditions which are not disclosed in this embodiment.

On the other hand, when the determination result at the step S1002 is Yes, whether the target pixel p or the adjacent pixel q is the inverse raster block prediction is determined (a step S1003). When a determination result at the step S1003 is Yes, whether the target pixel p or the adjacent pixel q is an extrapolation block is determined (a step S1005). When a determination result at the step S1005 is Yes, the filtering strength at the corresponding target block boundary is set to “medium” (BS≧2) (a step S1008). On the other hand, when the determination result at the step S1005 is No, the filtering strength at the corresponding target block boundary is set to “low” (BS≧1) (a step S1009).

On the other hand when the result of the determination upon whether the target pixel p or the adjacent pixel q is the inverse raster block prediction is No, whether the target pixel p or the adjacent pixel q is the bidirectional prediction is determined (a step S1006). When a determination result at the step S1006 is Yes, the filtering strength at the corresponding target block boundary is set to “low” (BS≧1) (a step S1010). When the determination result at the step S1006 is No, whether the target pixel p or the adjacent pixel q is a macro block boundary is determined (a step S1007). When a determination result at the step S1007 is Yes, the filtering strength at the corresponding target block boundary is set to “high” (BS≧3) (a step S1011). When the determination result at the step S1007 is No, the filtering strength at the corresponding target block is set to “medium” (BS≧2) (a step S1012).

The thus calculated filtering strength information 130 is supplied to a filtering strength changeover switch 107, and the locally decoded image signal 127 is subjected to the deblocking filter processing by using a pixel filter selected by the switch 107.

(Second Specific Example of Filtering Strength Determination Method)

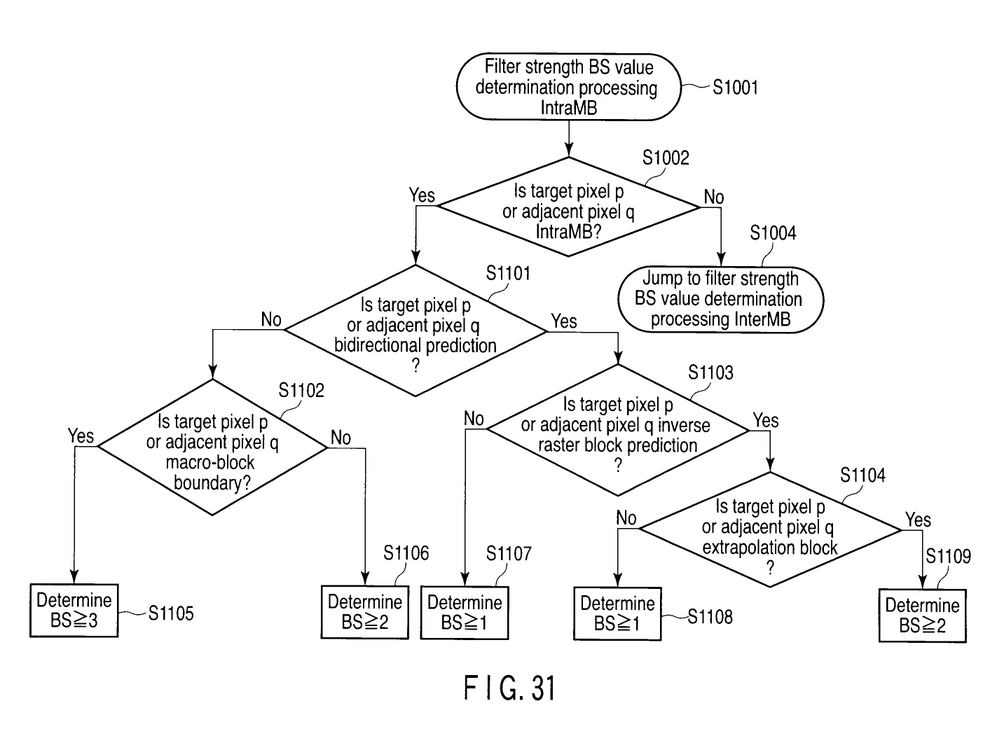

A second specific example of the filtering strength determination method in the second embodiment, especially a determination technique when determining the filtering strength will now be described with reference to FIG. 31. In FIG. 31, like reference numeral denotes each step at which similar processing as that in FIG. 30 is executed, thereby omitting an explanation.

When the determination result at the step S1002, i.e., the result of the determination upon whether the pixels p and q at the target block boundaries have been intra-coded is Yes, whether the target pixel p or the adjacent pixel q is the bidirectional prediction is determined (a step S1101). When a determination result at the step S1101 is No, whether the target pixel p or the adjacent pixel q is a macro block boundary is determined (a step S1102). When a determination result at the step S1102 is Yes, the filtering strength at the corresponding target block boundary is set to “high” (BS≧3) (a step S1105). On the other hand, when the determination result at the step S1101 is No, the filtering strength at the corresponding target block boundary is set to “medium” (BS≧2) (a step S1106).

On the other hand, when the determination result at the step S1001, i.e., the result of the determination upon whether the target pixel p or the adjacent pixel q is the bidirectional prediction is Yes, whether the target pixel p or the adjacent pixel q is the inverse raster block prediction is determined (a step S1103). When a determination result at the step S1103 is No, the filtering strength at the corresponding target block boundary is set to “low” (BS≧1) (a step S1107). When the determination result at the step S1103 is Yes, whether the target pixel p or the adjacent pixel q is an extrapolation block is determined (a step S1104).

When a determination result at the step S1104 is Yes, the filtering strength at the corresponding target block boundary is set to “medium” (BS≧2) (a step S1109). When the determination result at the step S1104 is No, the filtering strength at the corresponding target block boundary is set to “low” (BS≧1) (a step S1108).

The thus calculated filtering strength information 130 is supplied to the filtering strength changeover switch 107, and the locally decoded image signal 127 is subjected to the deblocking filter processing by a pixel filter selected by the switch 107.

As explained above, in the first and second embodiments, when the filtering strength of the deblocking filter processing is determined in accordance with the prediction complexity, an increase in image quality difference between an original image and a decoded image at a block boundary due to the excessive filter processing can be avoided, and an effect of improving a coding efficiency and also improving a subjective image quality can be successful.

It is to be noted that, at the time of encoding in a selected mode, generating a decoded image signal in the selected mode alone can suffice, and this generation does not have to be performed in a loop for determining a prediction mode.

### Modifications of First and Second Embodiments

(1) In the first and second embodiments, the example of repeatedly temporarily encoding the encoding loop for all combinations of target blocks has been explained. However, to simplify the calculation processing, temporary encoding may be performed with respect to a prediction mode and a block size alone which are apt to be selected in advance, and processing for combinations which are hardly selected may be omitted. When such selective temporary encoding is carried out, a reduction in coding efficiency can be suppressed, and a throughput required for the temporary encoding can be reduced.

(2) In the first and second embodiments, although the description has been given as to the example where a processing target frame is divided into rectangular blocks having, e.g., a 16×16 pixel size and the blocks are sequentially coded from an upper left position toward a lower left position in a screen as shown in FIG. 3, a coding order is not restricted thereto. For example, the coding may be sequentially performed from a lower right side toward an upper left side or sequentially spirally carried out from the center of the screen. Furthermore, the coding may be sequentially performed from the upper right side toward the lower left side, or the coding may be sequentially effected from a peripheral portion toward a central portion in the screen.

(3) In the first and second embodiments, the description has been given as to the case where the block size is the 4×4 pixel block or the 8×8 pixel block, but a target block does not have to have a uniform block shape, and it may have a block size such as a 16×8 pixel block, an 8×16 pixel block, an 8×4 pixel block, or a 4×8 pixel block. Moreover, the uniform block size does not have to be taken even in one macro block, and one macro block may have different block sizes. In this case, when a division number increases, a code rate for coding division information rises, but it is good enough to select a block size while considering a balance between a code rate of a transform coefficient and a locally decoded image.

(4) In the first and second embodiments, although a luminance signal and a color difference signal are not separately explained in particular, when the deblocking filter processing differs depending on the luminance signal and the color difference signal, the filtering strength determination method which differs depending on each signal may be used, or similar filtering strength determination method may be used. Additionally, when the deblocking filter processing differs in accordance with each of a plurality of color components, the filtering strength determination method may differ depending on each color component, or similar filtering strength determination method may be utilized.

### <Image Decoding Apparatus>

### Third Embodiment

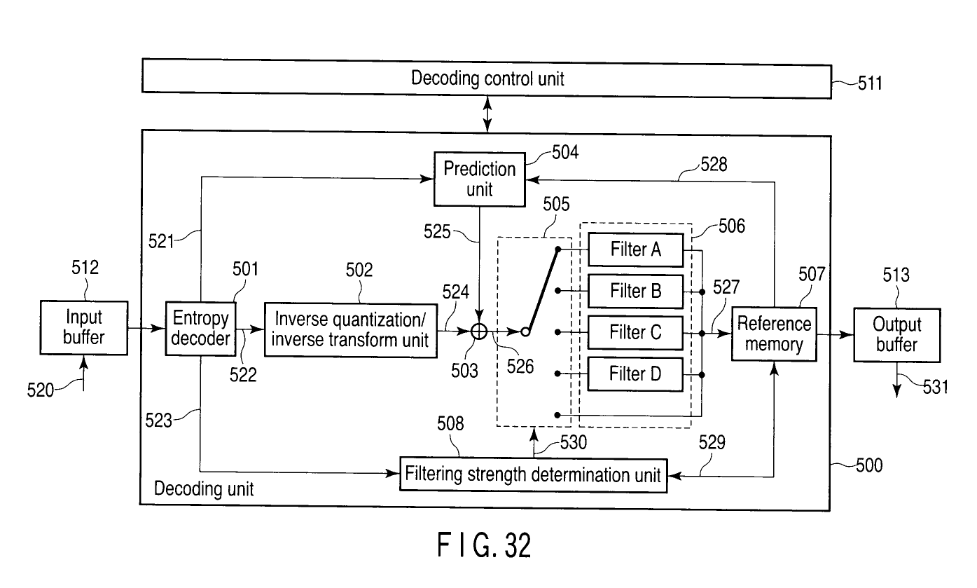

An image decoding apparatus according to a third embodiment of the present invention associated with the image encoding apparatus described in the first and second embodiments will now be explained. Referring to FIG. 32, in the image decoding apparatus according to the third embodiment, encoded data 520 supplied from the image encoding apparatus in FIG. 1 via a storage system or a transmission system is temporarily stored in an input buffer 512, and multiplexed encoded data is input to a decoding unit 500.

The decoding unit 500 has an entropy decoder 501, an inverse quantization/inverse transform unit 502, an adder 503, a prediction unit 504, a filtering strength changeover switch 505, a deblocking filter unit 506, a reference memory 507, and a filtering strength determination unit 508.

In the decoding unit 500, the encoded data 500 is input to the entropy decoder 501 through the input buffer 512 to be decoded by parsing based on syntax in accordance with each frame or each field. That is, the entropy decoder 501 sequentially performs entropy decoding with respect to a code string of each syntax to reproduce prediction information 521, a quantized transform coefficient 522 of a prediction error signal, and a coding parameter 523 of a target block. Here, the coding parameter 523 includes a prediction mode indicative of a prediction method, a prediction block index indicative of a prediction block size, prediction information 521 associated with a block prediction order, and it means all parameters required when decoding a moving image.

The quantized transform coefficient 522 decoded in the entropy decoder 501 is input to the inverse quantization/inverse transform unit 502. Various pieces of information concerning quantization decoded by the entropy decoder 501, i.e., a quantization parameter, a quantization matrix, and others are set in a decoding control unit 511 to be loaded when utilized for inverse quantization processing.

In the inverse quantization/inverse transform unit 502, loaded information concerning quantization is utilized to effect inverse quantization processing first, thereby generating a transform coefficient. Furthermore, in the inverse quantization/inverse transform unit 502, inverse orthogonal transform like inverse discrete cosine transform (DCT) is carried out with respect to a transform coefficient subjected to inverse quantization, thus generating a prediction error signal 524. Although the inverse orthogonal transform has been explained herein, the inverse quantization/inverse transform unit 502 performs inverse quantization and inverse wavelet transform when the image encoding apparatus carries out wavelet transform or the like.

The prediction error signal 524 output from the inverse quantization/inverse transform unit 502 is input to the adder 503 to be added to a predicted image signal 525 generated by the later-explained prediction unit 504, thus generating a decoded image signal 526 before the deblocking filter processing.

The decoded image signal 526 is input to the deblocking filter unit 506 via the filtering strength changeover switch 505 to be subjected to the deblocking filter processing by any one of pixel filters A to D of the filter unit 506. In the deblocking filter unit 506, a deblocking skip line E that does not effect the filter processing is provided.

A filter-processed decoded image signal 527 output from the deblocking filter 506 is stored in the reference memory 507. The decoded image signal 527 is sequentially read out from the reference memory 507 in accordance with each frame or each field and output from the decoding unit 500. The decoded image signal output from the decoding unit 500 is temporarily stored in an output buffer 513, and then it is output as an output image signal 531 in accordance with an output timing managed by the decoding control unit 511.

To the prediction unit 504, the prediction information 521 indicative of a prediction method decoded by the entropy decoder 501 is input, and a decoded image signal which has been already coded and stored in the reference memory 507 is input as a reference image signal 528.

The prediction unit 504 has a prediction changeover switch 201, an intra-prediction unit 202, an inter-prediction unit 203, and a subtracter 204 as shown in FIG. 6 like the prediction unit 101 in the image encoding apparatus. The prediction changeover switch 201 has a function of changing over the reference image signal 528 (132) in accordance with a prediction mode included in the prediction information 521 input to the prediction unit 504. When the prediction mode is the intra-prediction, the reference image signal 528 (132) is input to the intra-prediction unit 202. On the other hand, when the prediction mode is the inter-prediction, the reference image signal 528 (132) is input to the inter-prediction unit 203.

Each of the intra-prediction unit 202 and the inter-prediction unit 203 performs similar processing as that described in the first embodiment to generate the predicted image signal 525 (121). However, in the prediction unit 504, generating the predicted image signal 525 (121) in a prediction mode given by the prediction information 521 alone can suffice, and the predicted image signal in other modes than the given prediction mode does not have to be generated. For example, when the prediction mode given by the prediction information 521 is the inter-prediction, a shift amount in movement is calculated by using the motion vector information, and an image signal of a part indicated by this shift amount is determined as the predicted image signal 525. In this case, the reference image signal 528 may be interpolated in accordance with a motion vector accuracy in the inter-prediction unit 203.

The deblocking filter unit 506 will now be described. The coding parameter 523 of a target block decoded by the entropy decoder 501 is input to the filtering strength determination unit 508. Further, a coding parameter 529 of an adjacent block which has been stored in the reference memory 507 and already decoded is also input to the filtering strength determination unit 508. The filtering strength determination unit 508 has a function of using the two input coding parameters 523 and 529 to calculate filtering strength information 530 at a corresponding block boundary. The filtering strength determination unit 508 is as described in conjunction with FIG. 12 like the filtering strength determination unit 508 in the first embodiment, thereby omitting a detailed description thereof.

The filtering strength information 530 output from the filtering strength determination unit 508 is input to the filtering strength changeover switch 505. The filtering strength changeover switch 505 leads the decoded image signal 526 from the adder 503 to one of the pixel filters A to D or the deblocking skip line E in order to switch the filtering strength of the deblocking filter unit 506 in accordance with the filtering strength given by the filtering strength information 530.

The filtering strength information 530 is called a BS value. The decoded image signal 526 is led to the pixel filter A when the BS value is 4, the decoded image signal 526 is led to the pixel filter B when the BS value is 3, the decoded image signal 526 is led to the pixel filter C when the BS value is 2, or the decoded image signal 526 is led to the pixel filter D when the BS value is 1, whereby the deblocking filter processing is carried out. Moreover, the decoded image signal 526 is led to the deblocking skip line E when the BS value is 0 in order to avoid the deblocking filter processing. The decoded image signal 527 subjected to the deblocking filter processing by the deblocking filter unit 508 in this manner is stored in the reference memory 507 to be utilized for the next prediction.

(First Specific Example of Filtering Strength Determination Unit 508)

According to this embodiment, in the filtering strength determination unit 508, a prediction complexity derivation unit 303 calculates pieces of prediction complexity information 313 and 314 from prediction complexity derivation tables described in conjunction with FIGS. 13A, 13B, 14A, 14B, 15A, and 15B in accordance with prediction information 311 of a target block and prediction information 312 of an adjacent block extracted from a target block coding parameter extraction unit 301 and an adjacent block coding parameter extraction unit 302 shown in FIG. 2. Here, Expression (4) is used for calculating prediction complexity. Additionally, in the filtering strength information calculation unit 508, the final filtering strength information 530 (130) at a target block boundary is calculated from the pieces of prediction complexity information 313 and 314 by using Expressions (5) and (6).

Processing of the filtering strength determination unit 508 will now be described with reference to FIG. 17. The filtering strength determination unit 508 determines the filtering strength at block boundaries in both vertical and horizontal directions required for the deblocking filter processing carried out at the block boundaries (a step S601). The filtering strength is determined at all block boundaries placed at block boundaries in FIGS. 9A and 9B where the deblocking filter processing is effected. However, when a corresponding block boundary is a boundary of the image, the deblocking filter processing does not have to be performed.

First, whether a target pixel p and an adjacent pixel q at target block boundaries are pixels included in an intra-macro block, i.e., whether they have been intra-coded is determined (a step S602).

Here, when a determination result at the step S602 is No, since both the target block boundaries have been inter-coded, the processing jumps to a filtering strength (BS value) determination processing inter-macro block (a step S604). Here, the filtering strength of the inter-macro block is determined under other conditions which are not disclosed in this embodiment.

On the other hand, when the determination result at the step S602 is Yes, since the target pixel p or the adjacent pixel q has been intra-coded, whether the corresponding block boundary is a macro block boundary is determined (a step S603). When a determination result at the step S603 is Yes, the filtering strength determination unit 508 sets the filtering strength at the corresponding block boundary to “high” (BS≧3). Here, BS≧3 means that the BS value can possibly take a value that is equal to or above 3, and BS=3 or BS=4 is determined under other conditions that are not disclosed here. Thereafter, it is determined that an expression including such an inequality represents a range which can be determined by using conditions that are not disclosed in this embodiment.

That is, when the determination result at the step S603 is Yes, the filtering strength information 530 output from the filtering strength determination unit 508 is supplied to the filtering strength changeover switch 107, and the decoded image signal 526 output from the adder 526 is input to the filter B (BS=3) or the filter A (BS=4) (a step S605).

When the determination result at the step S603 is No, i.e., when the target pixel p and the adjacent pixel q are not the macro block boundaries, Expression (4) is used for calculating the prediction complexity of each target block boundary (a step S606), and then Expressions (5) and (6) are utilized to calculate the BS value (a step S607).

When the BS value obtained by Expression (6) is 4, the filtering strength information 530 of BS=4 is supplied to the filtering strength changeover switch 107 from the filtering strength determination unit 508, and the decoded image signal 526 is input to the filter A.

When the BS value is 3, the filtering strength information 530 of BS=3 is supplied to the filtering strength changeover switch 505 from the filtering strength determination unit 508, and the decoded image signal 526 is input to the filter B.

When the BS value is 2, the filtering strength information 530 of BS=2 is supplied to the filtering strength changeover switch 505 from the filtering strength determination unit 508, and the decoded image signal 526 is input to the filter C.

When the BS value is 1, the filtering strength information 530 of BS=1 is supplied to the filtering strength changeover switch 505 from the filtering strength determination unit 508, and the decoded image signal 526 is input to the filter D.

When the BS value is 0, the filtering strength information 530 of BS=0 is supplied to the filtering strength changeover switch 505 from the filtering strength determination unit 508, and the decoded image signal 526 is input to the deblocking skip line E.

(Second Specific Example of Filtering Strength Determination Unit)

A method obtained by simplifying the filtering strength determination procedure shown in FIG. 17 will now be described with reference to FIG. 18. In

FIG. 18, similar reference numerals as those in FIG. 17 denote similar processing steps as those in FIG. 17 to omit an explanation thereof.

As shown in FIG. 18, when the determination result at the step S603 is No, whether the target pixel p or the adjacent pixel q is subjected to the 8×8 prediction is determined (a step S701). Here, when a determination result at the step S701 is Yes, the filtering strength information 530 of BS=2 is supplied to the filtering strength changeover switch 505 from the filtering strength determination unit 508, and the decoded image signal 526 is input to the filter C. On the other hand, when the determination result at the step S701 is No, the filtering strength information 530 of BS=1 is supplied to the filtering strength changeover switch 505 from the filtering strength determination unit 508, and the decoded image signal 526 is input to the filter D.

(Third Specific Example of Filtering Strength Determination Unit 508)

A filtering strength determination method when the processing at the step S603 and the processing at the step S606 are counterchanged with respect to the filtering strength determination procedure depicted in FIG. 17 will now be described with reference to FIG. 19. In FIG. 19, similar reference numerals as those in FIG. 17 denote similar processing steps as those in FIG. 17 to omit an explanation thereof.

As shown in FIG. 19, when the determination result at the step S602 is Yes, Expression (4) is utilized to calculate the prediction complexity at the target block boundary of the target pixel p or the adjacent pixel q (a step S801). Moreover, Expressions (5) and (6) are utilized to calculate the prediction complexity at the corresponding block boundary. Whether the prediction complexity calculated here is Comp_Th is determined (a step S802). It is to be noted that Comp_Th=3.

When a determination result at the step S802 is Yes, the filtering strength information 530 of BS=1 is supplied to the filtering strength changeover switch 505 from the filtering strength determination unit 508, and the decoded image signal 526 is input to the filter D (a step S804). On the other hand, when the determination result at the step S802 is No, whether the target pixel p or the adjacent pixel q is a macro block boundary is determined (a step S803).

When the determination result at the step S803 is Yes, the filtering strength information 530 of BS=3 is supplied to the filtering strength changeover switch 505 from the filtering strength determination unit 508, and the decoded image signal 526 is input to the filter B (a step S805). On the other hand, when the determination result at the step S803 is No, the filtering strength information 530 is calculated by using Expression (6) (a step S806).

### Fourth Embodiment

A fourth embodiment according to the present invention will now be described. Although a configuration of an image decoding apparatus according to the fourth embodiment is the similar to that in the third embodiment, an intra-prediction unit 202 of a prediction unit 101 shown in FIG. 6 is different from that in the third embodiment, and a filtering strength determination unit 508 is also different from that in the third embodiment.

(Intra-Prediction Unit 202)

FIG. 20 shows an intra-prediction unit 202 in FIG. 6 based on the fourth embodiment, and it has a prediction order changeover unit 401, a unidirectional prediction unit 402, a bidirectional prediction unit 403, and a prediction changeover switch 404. As explained above, in this embodiment, the unidirectional prediction unit 402 and the bidirectional prediction unit 403 are provided as prediction units having different prediction methods.

The prediction order changeover unit 401 has a function of changing over a prediction order concerning sub-blocks in a macro block. That is, the prediction order changeover unit 401 selects a prediction order for a plurality of sub-blocks obtained by dividing a pixel block (a macro block) from a plurality of prediction orders. Information corresponding to the prediction order is included in prediction information 521, and it is directed from a prediction control unit 400 controlled by a decoding control unit 511. A reference image signal of the prediction order changed by the prediction order changeover unit 401 is input to the unidirectional prediction unit 402 and the bidirectional prediction unit 403.

Each of the unidirectional prediction unit 402 and the bidirectional prediction unit 403 makes reference to a coded pixel to predict the macro block in accordance with the prediction order changed over and selected by the prediction order changeover unit 401 and each selected prediction mode in order to generate a predicted image signal associated with the macro block. That is, the unidirectional prediction unit 402 makes reference to a reference image signal 528 (132) input through the prediction order changeover unit 401 based on the prediction mode directed by the prediction control unit 400 controlled by the decoding control unit 511, thereby generating a predicted image signal. The bidirectional prediction unit 403 likewise makes reference to a reference image signal 528 (132) input through the prediction order changeover unit 401 based on the prediction mode controlled by the prediction control unit 400 controlled by the decoding control unit 511, thereby generating a predicted image signal. Predicted image signals 525(121) output from the unidirectional prediction unit 402 and the bidirectional prediction unit 403 are input to the prediction changeover switch 404.

The prediction changeover switch 404 selects one of the predicted image signal generated by the unidirectional prediction unit 402 and the predicted image signal generated by the bidirectional prediction unit 403 in accordance with the prediction mode directed from the prediction control unit 400 controlled by the decoding control unit 511, whereby the selected predicted image signal 525 (121) is output. In other words, the prediction changeover switch 404 has a function of changeover the unidirectional prediction unit 402 and the bidirectional prediction unit 403 in accordance with the prediction mode included in prediction information of a target block decoded by an entropy decoder 501. The prediction mode is controlled by the prediction control unit 400 that is controlled by the decoding control unit 511 as described above.

An operation of the prediction order changeover unit 401 will now be described with reference to FIGS. 21A and 21B. FIG. 5B shows a division example of 8×8 pixel blocks, and indexes shown in the respective blocks denote block indexes (idx) in a raster scan order. On the other hand, each of FIGS. 21A and 21B shows a prediction order of sub-blocks (8×8 pixel blocks) in a macro block in the 8×8 pixel intra-prediction. Raster block prediction shown in FIG. 21A represents that respective 8×8 pixel blocks in a macro block are predicted in a raster order, and inverse raster block prediction shown in FIG. 21B represents that blocks are predicted in an order of block indexes 3, 1, 2 and 0 (this prediction block will be referred to as inverse raster block prediction and this prediction order will be referred to as an inverse raster order hereinafter).

Although an example of 4×4 pixel blocks is not shown in this embodiment, a macro block is divided as shown in FIG. 5A like the example of the 8×8 pixel blocks, then a raster block prediction order in 8×8 pixel blocks is given in case of the raster block prediction, and a raster order is given with respect to four 4×4 pixel blocks in an 8×8 pixel block. On the other hand, in regard to an inverse raster order, a raster block prediction order in 8×8 pixel blocks is given, and an inverse raster order is given with respect to four pixel blocks in an 8×8 pixel block.

There is the description on the operation of changeover the prediction order effected in the prediction order changeover unit 401. Although a prediction method for one 8×8 pixel block concerning the intra-prediction of 4×4 pixels will now be described, the intra-prediction of another 8×8 pixel block for 4×4 pixels and the intra-prediction for 8×8 pixels can be also carried out in accordance with similar procedure.

When the inverse raster block prediction is carried out with respect to processing blocks, there is provided a prediction order that one diagonal block in sub-blocks representing four 8×8 pixel blocks is first predicted based on extrapolation and remaining three blocks are predicted based on extrapolation or interpolation. The prediction based on such a prediction order will be referred to as interpolative/extrapolative prediction hereinafter. Processing by the unidirectional prediction unit 402 and the bidirectional prediction unit 403 associated with the prediction order will now be described.

(Example of Unidirectional Prediction in Case of Raster Block Prediction)

When the raster block prediction is set in the decoding control unit 511 and the prediction mode is unidirectional prediction, the unidirectional prediction unit 402 generates the predicted image signal 525 by the same prediction method as the method described as an example of H.264 in the first embodiment as shown in FIGS. 7 and 8.

(Example of Bidirectional Prediction in Case of Raster Block Prediction)

A description will be given as to a situation where the raster block prediction is set in the decoding control unit 511 and the prediction mode is bidirectional prediction. The bidirectional prediction unit 403 has a function of combining two predicted image signals generated by the unidirectional prediction to generate a predicted image signal. That is, assuming that a prediction value of a first unidirectional predicted image signal is P1 and a prediction value of a second unidirectional predicted image signal is P2, a predicted image signal is generated by using Expression (7) explained above.

(Example of Unidirectional Prediction in Case of Inverse Raster Block Prediction)

A description will now be given as to a situation where the inverse raster block prediction has been set in the decoding control unit 511 and the prediction mode is the unidirectional prediction. In such interpolation/extrapolation block prediction as explained in FIG. 21A, an order of respective sub-blocks in a macro block is changed to a prediction order based on the inverse raster block prediction from that based on the raster block prediction. For example, when predicting an 8×8 pixel block, as shown in FIG. 22A, one block at an outside corner is first predicted as a block that can be subjected to extrapolative prediction (which will be referred to as an extrapolation block hereinafter), and other three blocks are then predicted as blocks that can be subjected to interpolative prediction (which will be referred to as interpolation blocks hereinafter). That is, the extrapolation block (4) is first predicted, and then the interpolation blocks (2), (3), and (1) are predicted. On the other hand, when predicting a 4×4 pixel block, a prediction order is set by performing extrapolation block prediction and interpolation block prediction with respect to each 4×4 pixel block in units of 8×8 pixel block as shown in FIG. 22B.

The prediction processing in units of 8×8 pixel block when the 4×4 pixel prediction is selected will now be described. In this prediction processing, when the prediction in units of 8×8 pixel block is terminated, a subsequent 8×8 pixel block is predicted, namely, the prediction in units of 8×8 pixel block is repeated for four times.

(Extrapolation Block Prediction)

When predicting an extrapolation block, since reference pixels are distanced from predicted pixels, a range of the reference pixels is as shown in FIG. 23A. In FIG. 23A, pixels A to X and Z are reference pixels, and pixels a to p are predicted pixels. Although the range of the reference pixels is expanded, a technique of copying the reference pixels in accordance with a prediction angle to generate a predicted image signal is the same as that in the above-described raster block prediction. Specifically, a predicted image signal generation method when a mode 0 (vertical prediction) is selected is as represented by Expression (8). This mode 0 can be selected only when the reference pixels E to H are available. In the mode 0, when the reference pixels E to H are copied to the predicted pixels aligned in the vertical direction as they are as shown in FIG. 24, the predicted image signal is generated.

(Interpolation Block Prediction)

In FIGS. 22A and 22B, when predicting the interpolation block (2), since the prediction of the extrapolation block (4) has been terminated, the prediction that makes reference to pixels in the extrapolation block (4) can be performed. When predicting the interpolation block (3), reference can be made to pixels in the interpolation block (2) in addition to the extrapolation block (4) to effect the prediction. When predicting the extrapolation block (1), reference can be made to pixels in the interpolation block (3) in addition to the extrapolation block (4) and the interpolation block (2) to effect the prediction.

Each of FIGS. 23B, 23C, and 23D shows a relationship between the interpolation blocks (1), (2), and (3) and the reference pixels in the 4×4 pixel prediction. Pixels RA to RI are reference pixels newly added to FIG. 23A, and pixels a to p are predicted pixels.

(Processing of Unidirectional Prediction Unit 402 in Interpolation Block Prediction)

The unidirectional prediction unit 402 has a total of 17 modes of directional prediction in extrapolation blocks and inverse extrapolative prediction for making reference to reference pixels in a coded macro block in regard to the interpolation block prediction as shown in FIG. 25, and the 17 modes except a mode 2 have prediction directions shifted in increments of 22.5 degrees. Inverse prediction modes are added to prediction modes of the extrapolation block prediction (sequential block prediction) shown in FIG. 7. That is, respective modes of the vertical prediction, the horizontal prediction, the DC prediction, the diagonally lower left prediction, the diagonally lower right prediction, the vertical right prediction, the horizontal lower prediction, the vertical left prediction, and the horizontal upper prediction are also used in FIGS. 7 and 25 in common.

On the other hand, in FIG. 25, the inverse vertical prediction (a mode 9), the inverse horizontal prediction (a mode 10), the diagonally upper right prediction (a mode 11), the diagonally upper left prediction (a mode 12), the inverse vertical left prediction (a mode 13), the inverse horizontal upper prediction (a mode 14), the inverse vertical right prediction (a mode 15), and the inverse horizontal lower prediction (a mode 16) are added to the modes depicted in FIG. 7.

Whether the prediction mode can be selected is determined based on a positional relationship of the reference pixels with respect to the interpolation block and presence/absence of the reference pixels shown in FIGS. 22A and 22B. For example, in the interpolation block (1), since the reference pixels are arranged in all of left, right, upper, and lower directions, all modes 0 to 16 can be selected as depicted in FIG. 25. On the other hand, in the interpolation block (2), since the reference pixels are not arranged on the right-hand side, the mode 10, the mode 14, and the mode 16 cannot be selected. In the interpolation block (3), since the reference pixels are not arranged on the lower side, the mode 9, the mode 13, and the mode 15 can be selected.

A description will now be given as to a predicted image signal generation method of the unidirectional prediction unit 402 in the interpolation block prediction in case of the inverse raster block prediction. Specifically, when the mode 9 (the inverse vertical prediction) is selected, a predicted image signal is generated from the reference pixels placed at the nearest positions in the lower direction. In regard to each of the interpolation block (1) and the interpolation block (2), the predicted image signal is calculated in accordance with Expression (9).

Each of FIGS. 26A and 26B shows a method for generating a predicted image signal with respect to the interpolation block (1) and the interpolation block (2) in the mode 9. When the reference pixels RA to RD are copied to predicted pixels aligned in the vertical directions as they are, the predicted image signal is generated. In regard to the interpolation block (3), since the reference pixels are not present in the lower direction, the mode 9 cannot be utilized.

In relation to prediction modes other than the mode 9, a prediction method for copying a predicted image signal interpolated from the nearest pixels to which reference can be made in each prediction direction depicted in FIG. 25 is used. When the reference pixels are not arranged in the prediction direction, values of the nearest reference pixels may be copied to generate and utilize the reference pixels, or virtual reference pixels may be generated from the interpolation of the plurality of reference pixels and the virtual reference pixels may be utilized for the prediction.

(Example of Bidirectional Prediction in Case of Inverse Raster Block Prediction)

A description will now be given as to a case that the inverse raster block prediction is set in the decoding control unit 414 and the prediction mode is the bidirectional prediction. The bidirectional prediction unit 403 has a function of combining two predicted image signals generated by the unidirectional prediction based on the inverse raster block prediction to generate a predicted image signal. That is, Expression (7) is utilized to generate the predicted image signal of the bidirectional prediction. The predicted image signal generated as the unidirectional prediction means the predicted image signal 525 generated in accordance with a prediction mode indicated by each block index as shown in FIG. 25.

As explained above, the intra-prediction unit 302 in FIG. 20 includes the unidirectional prediction unit 402 and the bidirectional prediction unit 403 as the prediction units having different prediction methods and also includes the raster block prediction and the inverse raster block prediction as the prediction methods having different prediction orders. Additionally, as a combination of these types of prediction, there is a concept called an extrapolation block and an interpolation/extrapolation block.

(Filtering Strength Determination Unit 508)

In this embodiment, a determination technique of the filtering strength determination unit 508 varies with a change in the prediction unit 504. The filtering strength determination unit 508 in this embodiment will now be described. A configuration of the filtering strength determination unit 508 in this embodiment is similar to that in FIG. 12. However, a prediction complexity derivation table set in the prediction complexity derivation unit 303 is different.

FIG. 27 shows an example of the prediction complexity derivation table concerning the prediction method of the intra-prediction in this embodiment. The prediction complexity is high for the bidirectional intra-prediction which has higher prediction complexity than the unidirectional intra-prediction. As explained in conjunction with FIGS. 24, 25, 26A, and 26B, the unidirectional intra-prediction utilizes the prediction method of copying reference pixel values or pixel values obtained by interpolating the reference pixel values in a prediction direction. On the other hand, in the bidirectional prediction, filtering a predicted image signal generated by the unidirectional prediction enables generating a new predicted image signal. Since the deblocking filter processing is carried out with respect to a block boundary of the decoded image signal 526 generated by adding the predicted image signal 525 to the prediction error signal 524, the prediction complexity is set high with respect to the bidirectional prediction in which the filter processing is applied when generating the predicted image signal 525 as compared with the unidirectional prediction. Consequently, this processing is equal to setting the low filtering strength. Setting the prediction complexity in this manner enables preventing the deblocking processing from being excessively carried out with respect to block boundaries.

FIG. 28A shows a prediction complexity derivation table concerning a block prediction method in case of the inverse raster block prediction in an 8×8 pixel block of the intra-prediction according to this embodiment. As shown in FIG. 22A, in accordance with a prediction order, an index 0 (an index of a block that is predicted first) alone corresponds to an extrapolation block and other three blocks correspond to interpolation/extrapolation blocks. In regard to the extrapolation block, substantially the same prediction method as H.264 is adopted, and hence the prediction complexity is set to be higher than those of the interpolation/extrapolation blocks that the interpolative prediction can be used. Here, in the extrapolation block, since a distance from each reference pixel to a predicted pixel is long, reflecting spatial properties of an image in a prediction value is difficult. That is, the extrapolation block has a possibility that the prediction error signal 524 becomes large, and distortion at a block boundary tends to increase. Thus, in relation to the extrapolation block, the prediction complexity is set to be lower than those of the interpolation/extrapolation blocks, whereby the filtering strength of the deblocking filter is set to be rather high.

FIG. 28B shows a prediction complexity derivation table concerning a block prediction method and a distance from each reference pixel in the inverse raster block prediction in an 8×8 pixel block of the intra-prediction according to this embodiment. In the inverse raster block prediction, as already explained in conjunction with FIGS. 23A and 23B, a distance from the reference pixel that can be used in each sub-block is different. In an extrapolation block, since the interpolative prediction cannot be utilized as described above, the complexity is set to be lower than that of an interpolation/extrapolation block.

Each of FIGS. 29A and 29B shows a prediction complexity derivation table concerning each block index and the number of reference pixels in an 8×8 pixel block of the intra-prediction according to this embodiment. FIG. 29A shows an example of the raster block prediction, and FIG. 29B shows an example of the inverse raster block prediction. In FIG. 29A, since the number of reference pixels that can be used in accordance with each block index is not greatly different, the prediction complexity is the same in all blocks. On the other hand, in the inverse raster block prediction shown in FIG. 29B, as explained in conjunction with FIGS. 23A, 23B, 23C, and 23D, the number of reference pixels that can be used in each sub-block differs. Since the number of pixels that can be used in a prediction expression when the number of reference pixels is small is reduced to be smaller than that when more reference pixels can be utilized, the prediction complexity is low. That is, when the prediction order varies, the number of available reference pixels is changed, and a direction along which the prediction can be performed is also changed. As a result, there arises a tendency of a block that is easy to be predicted and a block that is difficult to be predicted depending on each prediction order. Thus, to increase the filtering strength of the block that is difficult to be predicted, such a prediction complexity table is set.

It is to be noted that each of FIGS. 28A, 28B, 29A, and 29B shows an example of the intra-prediction of an 8×8 pixel block, but similar technique can be utilized to create a prediction complexity derivation table for the intra-prediction of a 4×4 pixel block.

In the prediction complexity derivation unit 303 in FIG. 12, the above-described prediction complexity derivation table and Expression (4) are utilized to derive the prediction complexity information 313 of a target block and the prediction complexity information 314 of an adjacent block. When both the pieces of prediction complexity information 313 and 314 are input to the filtering strength information calculation unit 304, the final filtering strength information 530 (a BS value) at a corresponding block boundary is calculated by using Expressions (5) and (6). Thereafter, a procedure that the calculated filtering strength information 530 (130) is utilized to effect the filter processing is similar to the flow described in the second embodiment.

(First Specific Example of Filtering Strength Determination Method)

A first specific example of the filtering strength determination method in the fourth embodiment, specially a determination technique when determining the filtering strength will now be described with reference to FIG. 30.

The filtering strength determination unit 508 determines the filtering strength at each of both block boundaries in the vertical and horizontal directions required for the deblocking filter processing that is carried out at the block boundaries (a step S1001). The filtering strength is determined at all block boundaries placed at block boundaries in FIGS. 9A and 9B where the deblocking filter processing is effected. However, when a corresponding block boundary is a boundary of the image, the deblocking filter processing does not have to be carried out.

First, whether pixels p and q at target block boundaries have been intra-coded is determined (a step S1002). Here, when a determination result at the step S1002 is No, both the target block boundaries have been inter-coded, and hence the processing jumps to a filtering strength (BS value) determination processing inter-macro block (a step S1004). Here, the filtering strength of the inter-macro block is determined under other conditions which are not disclosed in this embodiment.

On the other hand, when the determination result at the step S1002 is Yes, whether the target pixel p or the adjacent pixel q is the inverse raster block prediction is determined (a step S1003). When a determination result at the step S1003 is Yes, whether the target pixel p or the adjacent pixel q is an extrapolation block is determined (a step S1005). When a determination result at the step S1005 is Yes, the filtering strength at the corresponding target block boundary is set to “medium” (BS≧2) (a step S1008). On the other hand, when the determination result at the step S1005 is No, the filtering strength at the corresponding target block boundary is set to “low” (BS≧1) (a step S1009).

On the other hand, when the result of the determination upon whether the target pixel p or the adjacent pixel q is the inverse raster block prediction is No, whether the target pixel p or the adjacent pixel q is the bidirectional prediction is determined (a step S1006). When a determination result at the step S1006 is Yes, the filtering strength at the corresponding target block boundary is set to “low” (BS≧1) (a step S1010). When the determination result at the step S1006 is No, whether the target pixel p or the adjacent pixel q is a macro block boundary is determined (a step S1007). When a determination result at the step S1007 is Yes, the filtering strength at the corresponding target block boundary is set to “high” (BS≧3) (a step S1011). When the determination result at the step S1007 is No, the filtering strength at the corresponding target block is set to “medium” (BS≧2) (a step S1012).

The thus calculated filtering strength information 530 is supplied to a filtering strength changeover switch 505, and the decoded image signal 526 is subjected to the deblocking filter processing by using a pixel filter selected by the switch 505.

(Second Specific Example of Filtering Strength Determination Method)

A second specific example of the filtering strength determination method in the fourth embodiment, especially a determination technique when determining the filtering strength will now be described with reference to FIG. 31. In FIG. 31, like reference numeral denotes each step at which similar processing as that in FIG. 30 is executed, thereby omitting an explanation.

When the determination result at the step S1002, i.e., the result of the determination upon whether the pixels p and q at the target block boundaries have been intra-coded is Yes, whether the target pixel p or the adjacent pixel q is the bidirectional prediction is determined (a step S1101). When a determination result at the step S1101 is No, whether the target pixel p or the adjacent pixel q is a macro block boundary is determined (a step S1102). When a determination result at the step S1102 is Yes, the filtering strength at the corresponding target block boundary is set to “high” (BS≧3) (a step S1105). On the other hand, when the determination result at the step S1101 is No, the filtering strength at the corresponding target block boundary is set to “medium” (BS≧2) (a step S1106).

On the other hand, when the determination result at the step S1001, i.e., the result of the determination upon whether the target pixel p or the adjacent pixel q is the bidirectional prediction is Yes, whether the target pixel p or the adjacent pixel q is the inverse raster block prediction is determined (a step S1103). When a determination result at the step S1103 is No, the filtering strength at the corresponding target block boundary is set to “low” (BS≧1) (a step S1107). When the determination result at the step S1103 is Yes, whether the target pixel p or the adjacent pixel q is an extrapolation block is determined (a step S1104).

When a determination result at the step S1104 is Yes, the filtering strength at the corresponding target block boundary is set to “medium” (BS≧2) (a step S1109). When the determination result at the step S1104 is No, the filtering strength at the corresponding target block boundary is set to “low” (BS≧1) (a step S1108).

The thus calculated filtering strength information 530 is supplied to the filtering strength changeover switch 505, and the decoded image signal 526 is subjected to the deblocking filter processing by a pixel filter selected by the switch 505.

As explained above, in the third and fourth embodiments, when the filtering strength of the deblocking filter processing is determined in accordance with the prediction complexity, an increase in image quality difference between an original image and a decoded image at a block boundary due to the excessive filter processing can be avoided, and an effect of improving a coding efficiency and also improving a subjective image quality can be successful.

It is to be noted that, at the time of decoding in a selected mode, generating a decoded image signal in the selected mode alone can suffice, and this generation does not have to be performed in a loop for determining a prediction mode.

It is to be noted that the present invention is not restricted to the foregoing embodiments as it is, and constituent elements can be modified and embodied without departing from the scope on the embodying stage. Further, appropriately combining a plurality of constituent elements disclosed in the foregoing embodiments enables forming various kinds of inventions. For example, some of all constituent elements disclosed in the embodiments can be deleted. Furthermore, constituent elements in the different embodiments can be appropriately combined.

What is claimed is:

1. An image encoding method comprising:
performing prediction processing by using a reference image signal in accordance with a selected prediction mode in units of block obtained by dividing an image frame in order to generate a predicted image signal in units of prediction block;
performing transform and quantization with respect to a prediction error signal indicative of a difference value between the predicted image signal and an input image signal in order to generate a quantized transform coefficient;
performing entropy encoding with respect to the quantized transform coefficient in order to generate encoded data;
performing inverse quantization and inverse transform with respect to the quantized transform coefficient in order to generate a decoded prediction error signal;
adding the predicted image signal to the decoded prediction error signal in order to generate a locally decoded image signal;
deriving prediction complexity indicative of a degree of complication of the prediction processing;
determining filtering strength for the locally decoded image signal to become low as the prediction complexity increases;
performing deblocking filter processing with respect to the locally decoded image signal in accordance with the filtering strength; and
storing the locally decoded image signal after deblocking filter processing to be used as the reference image signal.
